(19) United States
(12) Patent Application Publication
(10) Pub. No.: US 2016/0369015 A1
(43) Pub. Date: Dec. 22, 2016

(54) Silane Modified Elastomeric Polymers

(71) Applicant: Trinseo Europe GmbH, Horgen (CH)

(72) Inventors: Christian Doring, Markranstadt (DE); Sven Thiele, Halle (DE); Daniel Heidenreich, Halle (DE)

(73) Assignee: Trinseo Europe GmbH, Horgen (CH)

(21) Appl. No.: 15/103,111

(22) PCT Filed: Dec. 9, 2013
(86) PCT No.: PCT/EP2013/075909

§ 371 Date: Jun. 9, 2016

(51) Int. Cl. C08C 19/25; C08F 236/06

(52) U.S. Cl. CPC C08C 19/25; C08F 236/06; C08F 2810/40; C08F 2500/17

(57) ABSTRACT

The present invention relates to backbone-modified elastomeric polymers. The invention also relates to polymer compositions comprising such modified polymers, to the use of such compositions in the preparation of vulcanized polymer compositions, and to articles prepared from the same. The modified polymers are useful in the preparation of vulcanized, i.e. cross-linked, elastomeric compositions having relatively low hysteresis loss. Such vulcanized compositions are useful in many articles, including tire treads having low heat build-up, low rolling resistance, good wet grip and ice grip, in combination with a good balance of other desirable physical and chemical properties, for example, abrasion resistance and tensile strength. Moreover, the unvulcanized poly mer compositions exhibit excellent processability.

### FIELD OF THE INVENTION

This invention relates to backbone-modified (backbone-functionalized) polymers. The invention also relates to polymer compositions comprising such modified polymers, to the use of such compositions in the preparation of vulcanized polymer compositions, and to articles prepared from the same. The modified polymers are useful in the preparation of vulcanized, i.e. cross-linked, elastomeric compositions having relatively low hysteresis loss. Such compositions are useful in many articles, including tire treads having low heat build-up, low rolling resistance, good wet grip and ice grip, in combination with a good balance of other desirable physical and chemical properties, for example, abrasion resistance and tensile strength and excellent processability.

### BACKGROUND OF THE INVENTION

Increasing oil prices and national legislation requiring the reduction of automotive carbon dioxide emissions force tire and rubber producers to produce “fuel-efficient” tires. One general approach to obtain fuel-efficient tires is to produce tire formulations which have reduced hysteresis loss. A major source of hysteresis in vulcanized elastomeric polymers is attributed to free polymer chain ends, i.e. the section of the elastomeric polymer chain between the last cross-link and the end of the polymer chain. The free end of the polymer does not participate in the efficient elastically recoverable process and, as a result, energy transmitted to this section of the polymer is lost. This dissipated energy leads to a pronounced hysteresis under dynamic deformation. Another source of hysteresis in vulcanized elastomeric polymers is attributed to an insufficient distribution of filler particles in the vulcanized elastomeric polymer composition. The hysteresis loss of a cross-linked elastomeric polymer composition is related to its tan δ value at 60° C. (see ISO 4664-1:2005; Rubber, Vulcanized or thermoplastic; Determination of dynamic properties—part 1: General guidance). In general, vulcanized elastomeric polymer compositions having relatively small tan δ values at 60° C. are preferred as having lower hysteresis loss. In the final tire product, this translates into a lower rolling resistance and better fuel economy.

It is generally accepted that a lower rolling resistance tire can be made at the expense of deteriorated wet grip properties. For example, if, in a random solution styrene-butadiene rubber (random SSBR), the polystyrene unit concentration is relatively reduced with respect to the total polybutadiene unit concentration, and the 1,2-polydiene unit concentration is kept constant, the SSBR glass transition temperature is reduced and, as consequence, both tan δ at 60° C. and tan δ at 0° C. are reduced, generally corresponding to improved rolling resistance and deteriorated wet grip performance of the tire. Similarly, if, in a random solution styrene-butadiene rubber (random SSBR), the 1,2-polybutadiene unit concentration is relatively reduced with respect to the total polybutadiene unit concentration, and the polystyrene unit concentration is kept constant, the SSBR glass transition temperature is reduced and, as consequence, both tan δ at 60° C. and tan δ at 0° C. are reduced. Accordingly, when assessing the rubber vulcanizate performance correctly, both the rolling resistance, related to tan δ at 60° C., and the wet grip, related to tan δ at 0° C., should be monitored along with the tire heat build-up.

WO2007/047943 describes the use of a silane sulfide omega chain end modifier for producing a chain end-modified elastomeric polymer, which can be used in a vulcanized elastomeric polymer composition for use in a tire tread. A silane sulfide compound is reacted with anionically-initiated living polymers to produce “chain end-modified” polymers, which are subsequently blended with fillers, vulcanizing agents, accelerators or oil extenders to produce a vulcanized elastomeric polymer composition having low hysteresis loss. When the modifier contains two or three alkoxy groups, the resulting functionalized polymer contains —Si—OR groups and —S—SiR₃ groups, which, in conditions as typically present during reactive mixing of functionalized polymers with fillers, will be converted into silanol groups (—Si—OH) and thiol groups (—S—H). Silanol groups and thiol groups are reactive towards fillers containing silanol surface groups, such as silica, while thiol groups are easily converted into thio radicals. Thus, the formation of functionalized polymer-silica bonds and functionalized polymer-polymer bonds is expected. Although cured rubber hysteresis properties can be improved significantly with this technology, its impact is limited as only one polymer chain end can be functionalized with the modifier compound. Furthermore, there is no disclosure of any cooperative effect of polymers modified by the silane sulfide modifier at one chain end and with other modifiers at the second polymer chain end or the polymer backbone.

JP 2010 168528 describes the hydrosilylation of polybutadiene rubber wherein the polybutadiene fraction has a cis-1,4 content of 80% or more and a 1,2 content of not more than 20%. The polymers are made by polymerizing 1,3-butadiene in the presence of a metallocene complex of a transition metal. Rubber formulations comprising the hydrosilylated polybutadienes and silica are reported to result in a reduced tan δ value at 50° C. and a reduced heat build-up. The improved rubber formulations contain polybutadienes hydrosilylated with triethoxysilane, 1,1,1,3,5,5,5-heptamethyltrisiloxane or dimethylsilyldiethylamine. The examples of JP 2010 168528 use a modification degree of SiH/vinyl of 0.25-1 mol/mol. Higher modification degrees are said to lead to a reaction of the silane molecules and thus to a deteriorated addition efficiency. JP 2010 168528 does not demonstrate any cooperative effect of the hydrosilylated polymers with other modifiers such as end-capping agents.

EP 0 874 001 describes the modification of crystalline polybutadiene having a trans-1,4 content of 75-96% and a 1,2 content of 5-20% with a specific silane as well as vulcanized elastomeric rubber compositions comprising the modified polymers and carbon black and silica as fillers. The vulcanized rubber compositions are described as exhibiting lower tan δ at 50° C., particularly in comparison with compounds based on corresponding non-modified polymers. Nevertheless, the performance benefit of the cured rubber samples is exclusively reflected by reduced values of tan δ at 50° C., which are indicators for a reduced rolling resistance of a tire. There are no measurements of cured rubber heat build-up, rebound resilience at 60° C. or Payne effect. Furthermore, there is no indication of other key performance criteria, particularly tan δ at 0° C. as a tire wet grip performance indicator, tan δ at −10° C. as a tire ice grip performance indicator and abrasion resistance of the cured silica-filled rubber samples.

Generally, SSBR is industrially produced via anionic polymerization of styrene (an aromatic vinyl compound) and 1,3-butadiene (a conjugated diene) using an organolithium initiator in an inert organic solvent. The polymeric chain ends thus obtained are anionic or “living”. Reacting the living chain ends with a functionalizing agent (modifier or modifying agent) leads to chain end-modified polymer chains. Yet, the chain end functionalization produces only one modification or functional group per polymer chain, and the effect of the chain end modification cannot be increased by using a higher amount of modifier. Furthermore, the use of coupling agents, which are commonly used to improve polymer processability, reduces the amount of living chain ends available for chain end functionalization.

In accordance with the present invention, it has been found that a modification at the backbone of the polymer chain allows to introduce more than one functional group per polymer chain and to obtain an associated increase of the effects of the modifying agent.

### SUMMARY OF THE INVENTION

In a first aspect, the present invention provides a modified elastomeric polymer which is the reaction product of:
i) a homopolymer of butadiene having a vinyl group content of at least 20 wt % or a copolymer of butadiene and one or more comonomers selected from conjugated dienes and aromatic vinyl compounds, wherein the copolymer contains at least 10 wt % of butadiene units and a total amount of at least 40 wt % of conjugated diene units (including butadiene) and wherein the polybutadiene fraction of said copolymer has a vinyl group content of at least 20 wt %, and
ii) a silane modifier represented by the following Formula 1:

(H)ₙSi(X)ₘ(R¹)ₚ (Formula 1),

wherein
X is independently selected from Cl, —OR², —SR³ and —NR⁴R⁵;
R¹ is independently selected from (C1-C6) alkyl and (C6-C18) aryl;
n is an integer selected from 1, 2 and 3; m and p are each independently an integer selected from 0, 1, 2 and 3; and n+m+p=4;
R² and R³ are independently selected from hydrogen, (C1-C18) alkyl, (C6-C18) aryl, (C7-C18) alkylaryl and MR⁶R⁷R⁸;
R⁴ and R⁵ are independently selected from (C1-C18) alkyl, (C6-C18) aryl, (C7-C18) alkylaryl and MR⁹R¹⁰R¹¹; R⁴ and R⁵ may be bonded together to form, together with the nitrogen atom, a ring structure which may additionally include within the ring one or more groups selected from —O—, —S—, >NH and >NR¹²;
M is silicon or tin;
R⁶, R⁷, R⁸, R⁹, R¹⁰, R¹¹ and R¹² are independently selected from (C1-C6) alkyl.

In a second aspect, the invention further provides a method of making the modified elastomeric polymer as defined herein (“backbone modification process”), said method comprising the steps of reacting
i) a homopolymer of butadiene having a vinyl group content of at least 20 wt % or a copolymer of butadiene and one or more comonomers selected from conjugated dienes and aromatic vinyl compounds, wherein the copolymer contains at least 10 wt % of butadiene units and a total amount of at least 40 wt % of conjugated diene units (including butadiene) and wherein the polybutadiene fraction of said copolymer has a vinyl group content of at least 20 wt %, with
ii) a silane modifier represented by Formula 1 as defined herein.

In a third aspect, the invention provides a non-cured polymer composition comprising:
1) the modified elastomeric polymer of the invention as defined herein and
2) one or more further components selected from (i) components which are added to or formed as a result of the polymerization process and/or backbone modification process used for making said polymer, (ii) components which remain after solvent removal from the polymerization and/or backbone modification process, and (iii) components which are added to the polymer after completion of the polymerization and/or backbone modification process.

In a fourth aspect, the invention further provides a vulcanized polymer composition which is obtained by vulcanizing a non-cured polymer composition of the invention, i.e. comprising the reaction product of:
1) the modified elastomeric polymer of the invention as defined herein,
2) one or more further components selected from (i) components which are added to or formed as a result of the polymerization process and/or backbone modification process used for making said polymer, (ii) components which remain after solvent removal from the polymerization and/or backbone modification process, and (iii) components which are added to the polymer after completion of the polymerization and/or backbone modification process, and
3) at least one vulcanizing agent.

In a fifth aspect, the present invention provides an article comprising at least one component formed from the vulcanized polymer composition of the invention.

### DETAILED DESCRIPTION OF THE INVENTION

The modified elastomeric polymer of the first aspect of the present invention is the reaction product of a homopolymer of butadiene or a copolymer of butadiene and one or more comonomers selected from conjugated dienes and aromatic vinyl compounds, wherein the copolymer contains at least 10 wt % of butadiene units and a total amount of at least 40 wt % of conjugated diene units (including butadiene) and wherein the polybutadiene fraction of said copolymer has a vinyl group content of at least 20 wt %, and a silane compound represented by Formula 1 as defined herein.

### Silane Modifier of Formula 1 (Backbone Modifier Agent)

The silane modifier used in the present invention, also referred to as a backbone modifier agent or backbone modifying agent, is a compound of Formula 1 as defined herein.

In the silane modifier of Formula 1, X is preferably independently selected from Cl, —OR² and —NR⁴R⁵ and more preferably from —OR² and —NR⁴R⁵. When X is —OR², R² is preferably selected from (C1-C18) alkyl, more preferably from (C1-C12) alkyl and even more preferably from (C1-C8) alkyl. When X is —SR³, R³ is preferably selected from (C1-C18) alkyl, more preferably from (C1-C12) alkyl and even more preferably from (C1-C8) alkyl. When X is —NR⁴R⁵, R⁴ and R⁵ are preferably independently selected from (C1-C18) alkyl, more preferably from (C1-C12) alkyl and even more preferably from (C1-C8) alkyl. Specific preferred embodiments of —NR⁴R⁵ include —NMe₂, —NEt₂, —NPr₂, —NBu₂, —N(CH₂Ph)₂, —N(pentyl)₂, —N(cyclhexyl)₂, —N(octyl)₂, morpholino [—N(CH₂)₂O], piperidino [—N(CH₂)₅], N-methyl piperazino [—N(CH₂)₂NMe] and pyrrolidino [—N(CH₂)₄].

In the silane modifier of Formula 1, R¹ is preferably independently selected from methyl, ethyl, propyl, butyl and phenyl.

In the silane modifier of Formula 1, preferably n is 1, m is an integer selected from 1, 2 and 3, and p is an integer selected from 0, 1 and 2.

In specific embodiments, X is independently selected from —OR² and —NR⁴R⁵, R¹ is independently selected from methyl, ethyl, propyl, butyl and phenyl, n is 1, m is an integer selected from 1, 2 and 3 and p is an integer selected from 0, 1 and 2.

Specific preferred examples of the silane modifier used in the invention include HSi(OMe)₃, HSi(Me)(OMe)₂, HSi(Me)₂(OMe), HSi(Et)(OMe)₂, HSi(Et)₂(OMe), HSi(Pr)(OMe)₂, HSi(Pr)₂(OMe), HSi(Bu)(OMe)₂, HSi(Bu)₂(OMe), HSi(Ph)(OMe)₂, HSi(Ph)₂(OMe), HSi(OEt)₃, HSi(Me)(OEt)₂, HSi(Me)₂(OEt), HSi(Et)(OEt)₂, HSi(Et)₂(OEt), HSi(Pr)(OEt)₂, HSi(Pr)₂(OEt), HSi(Bu)(OEt)₂, HSi(Bu)₂(OEt), HSi(Ph)(OEt)₂, HSi(Ph)₂(OEt), tris(trimethylsiloxy)silane, HSi(Cl)₃, H₂Si(Cl)₂, HSi(Me)(Cl)₂, HSi(Me)₂(Cl), HSi(Et)(Cl)₂, HSi(Et)₂(Cl), HSi(Pr)(Cl)₂, HSi(Pr)₂(Cl), HSi(Bu)(Cl)₂, HSi(Bu)₂(Cl), HSi(Ph)(Cl)₂, HSi(Ph)₂(Cl₂), H₂Si(Ph)(Cl), HSi(Ph)(Me)(Cl), 1,1,1,3,5,5,5-heptamethyltrisiloxane, (Me)₂NSi(H)(Me)₂, (Et)₂NSi(H)(Me)₂, (Pr)₂NSi(H)(Me)₂, (Bu)₂NSi(H)(Me)₂, ((Me)₂N)₂Si(H)(Me), ((Et)₂N)₂Si(H)(Me), ((Pr)₂N)₂Si(H)(Me), ((Bu)₂N)₂Si(H)(Me), ((Me)₂N)₃Si(H), ((a)₂N)₃Si(H), ((Pr)₂N)₃Si(H), ((Bu)₂N)₃Si(H), (Me)₂NSi(H)(Ph)₂, (Et)₂NSi(H)(Ph)₂, (Pr)₂NSi(H)(Ph)₂, (Bu)₂NSi(H)(Ph)₂, ((Me)₂N)₂Si(H)(Ph), ((Et)₂N)₂Si(H)(Ph), ((Pr)₂N)₂Si(H)(Ph), ((Bu)₂N)₂Si(H)(Ph), (Me)₂NSi(H)(Cl)₂, (Et)₂NSi(H)(Cl)₂, (Pr)₂NSi(H)(Cl)₂, (Bu)₂NSi(H)(Cl)₂, ((Me)₂N)₂Si(H)(Cl), ((Et)₂N)₂Si(H)(Cl), ((Pr)₂N)₂Si(H)(Cl) and ((Bu)₂N)₂Si(H)(Cl).

### Unmodified Polymer and Constituting Monomers

The unmodified polymer, which is subjected to backbone modification in the present invention, is a homopolymer of butadiene or a copolymer of butadiene and one or more comonomers selected from conjugated dienes (conjugated diene monomers) and aromatic vinyl compounds (aromatic vinyl monomers). The copolymer contains at least 10 wt % of butadiene, preferably at least 20 wt % and more preferably at least 30 wt %, and contains a total amount of at least 40 wt % of conjugated diene(s) (including butadiene), preferably at least 50 wt %. The homopolymer (of butadiene) or the polybutadiene fraction of the copolymer has a vinyl group content of at least 20 wt %, preferably at least 30 wt %.

Exemplary conjugated dienes (other than 1,3-butadiene (“butadiene”)) useful in the present invention include 2-(C1-C5 alkyl)-1,3-butadiene such as isoprene (2-methyl-1,3-butadiene). 2,3-dimethyl-1,3-butadiene, 1,3-pentadiene, 2,4-hexadiene, 1,3-hexadiene, 1,3-heptadiene, 1,3-octadiene, 2-methyl-2,4-pentadiene, cyclopentadiene, 2,4-hexadiene, 1,3-cyclohexadiene and 1,3-cyclooctadiene. Two or more conjugated dienes may be used in combination. Preferred conjugated dienes include isoprene and cyclopentadiene.

Exemplary aromatic vinyl compounds useful in the present invention include monovinylaromatic compounds, i.e. compounds having a single vinyl group attached to an aromatic group, and di- or higher vinylaromatic compounds which have two or more vinyl groups attached to an aromatic group. Exemplary aromatic vinyl compounds include styrene, C1-C4 alkyl-substituted styrene such as 2-methylstyrene, 3-methylstyrene, 4-methylstyrene, 2,4-dimethylstyrene, 2,4,6-trimethylstyrene, α-methylstyrene, 2,4-diisopropylstyrene and 4-tert-butylstyrene, stilbene, vinyl benzyl dimethylamine, (4-vinylbenzyl)dimethyl aminoethyl ether, N,N-dimethylaminoethyl styrene, tert-butoxystyrene, vinylpyridine, and divinylaromatic compounds such as 1,2-divinylbenzene, 1,3-divinylbenzene and 1,4-divinylbenzene. Two or more aromatic vinyl compounds may be used in combination. A preferred aromatic vinyl compound is a monovinylaromatic compound, more preferably styrene. The di- or higher vinylaromatic compounds such as divinylbenzene, including 1,2-divinylbenzene, 1,3-divinylbenzene and 1,4-divinylbenzene, may be used in a total amount of 1 wt. % or less (based on the total molar weight of the monomers used to make the polymer). In one preferred embodiment, 1,4-divinylbenzene is used in combination with butadiene, styrene as the aromatic vinyl compound and optionally isoprene as the conjugated diene monomer.

For most applications, the aromatic vinyl compound(s) will constitute from 5 to 60% by weight of the total monomer content and more preferably from 10 to 50% by weight. Contents of less than 5% by weight may lead to reduced wet skid properties, abrasion resistance, and tensile strength; whereas contents of more than 60% by weight may lead to increased hysteresis loss.

The elastomeric copolymer may be a block or random copolymer, and preferably 40% by weight or more of the aromatic vinyl compound units are linked singly, and preferably 10% by weight or less are “blocks” in which eight or more aromatic vinyl compounds are linked contiguously. Copolymers falling outside this range often exhibit increased hysteresis loss. The length of contiguously linked aromatic vinyl units can be measured by an ozonolysis-gel permeation chromatography method developed by Tanaka et al. (Polymer, Vol. 22, Pages 1721-1723 (1981)).

Comonomers other than the conjugated dienes and the aromatic vinyl compounds, which may be used in preparing the elastomeric copolymer of the invention, include acrylic monomers such as acrylonitrile, acrylates, e.g., acrylic acid, methyl acrylate, ethyl acrylate, propyl acrylate and butyl acrylate, and methacrylates, e.g., methyl methacrylate, ethyl methacrylate, propyl methacrylate and butyl methacrylate. The total amount of such other comonomers preferably does not exceed 10 wt % and more preferably does not exceed 5 wt % of all monomers. In a most preferred embodiment, no comonomers other than the conjugated dienes and the aromatic vinyl compounds are used.

Preferred unmodified polymers and copolymers for use in the present invention include butadiene rubber (BR), styrene-butadiene rubber (SBR), butadiene-isoprene rubber and butadiene-isoprene-styrene rubber, more preferably styrene-butadiene rubber with a styrene content of from 5 to 60% by weight of the total monomer content and more preferably from 10 to 50% by weight of the total monomer content.

For producing vehicle tires, the following polymers are of particular interest for backbone modification in accordance with the present invention: natural rubber; emulsion SBR and solution SBR rubbers with a glass transition temperature above −50° C.; polybutadiene rubber with a vinyl group content of at least 20 wt %; and combinations of two or more thereof.

### Polymerization

The unmodified polymer (homopolymer or copolymer) used in the present invention is prepared by (co)polymerization of the constituting monomers in accordance with conventionally known practice in the art of polymers. The elastomeric polymer can be prepared generally via anionic, radical or transition metal-catalyzed polymerization, but is preferably prepared by anionic polymerization. The polymerization may be conducted in a solvent and may be carried out with one or more of chain end-modifying agents, coupling agents incl. modified coupling agents, randomizer compounds and polymerization accelerator compounds. Suitable polymerization techniques, components for increasing the reactivity of the initiator, randomly arranging aromatic vinyl compounds and randomly arranging 1,2-polybutadiene or 1,2-polyisoprene or 3,4-polyisoprene units introduced in the polymer, amounts of each component, and suitable process conditions are described, for instance, in WO 2009/148932, fully incorporated herein by reference.

The polymerization can be conducted under batch, continuous or semi-continuous conditions. The polymerization process is preferably conducted as a solution polymerization, wherein the resulting polymer is substantially soluble in the reaction mixture, or as a suspension/slurry polymerization, wherein the polymer is substantially insoluble in the reaction medium. As the polymerization solvent, a hydrocarbon solvent is conventionally used which does not deactivate the initiator, catalyst or active polymer chain. The polymerization solvent may be a combination of two or more solvents. Exemplary hydrocarbon solvents include aliphatic and aromatic solvents. Specific examples include (including all conceivable constitutional isomers): propane, butane, pentane, hexane, heptane, butene, propene, pentene, hexane, octane, benzene, toluene, ethylbenzene and xylene.

### Initiators

Polymerization of the aforementioned monomers is typically initiated with an anionic initiator compound, such as, but not limited to, an organometal compound having at least one lithium, sodium, potassium or magnesium atom, the organometal compounds containing from 1 to about 20 carbon atoms. Two or more initiator compounds may be used in combination. The organometal compound preferably contains at least one lithium atom, and exemplary compounds include ethyllithium, propyllithium, n-butyllithium, sec-butyllithium, tert-butyllithium, phenyllithium, hexyllithium, 1,4-dilithio-n-butane, 1,3-di(2-lithio-2-hexyl)benzene and 1,3-di(2-lithio-2-propyl)benzene, preferably n-butyllithium and sec-butyllithium. The amount of the initiator compound will be adjusted based on the monomers to be polymerized and the target molecular weight of the polymer. The total amount of initiator is typically 0.1 to 10 mmol, preferably 0.2 to 5 mmol per 100 grams of monomers (total polymerizable monomers).

### Randomizer Agents

Polar coordinator compounds, also referred to as randomizer agents, may optionally be added to the polymerization to adjust the microstructure of the conjugated diene portion (including the content of vinyl bonds of the polybutadiene fraction), or to adjust the composition distribution of the aromatic vinyl compound, thus serving as a randomizer component. Two or more randomizer agents may be used in combination. Exemplary randomizer agents are Lewis bases and include, but are not limited to, ether compounds, such as diethyl ether, di-n-butyl ether, ethylene glycol diethyl ether, ethylene glycol dibutyl ether, diethylene glycol dimethyl ether, propylene glycol dimethyl ether, propylene glycol diethyl ether, propylene glycol dibutyl ether, alkyltetrahydrofurylethers, such as methyltetrahydrofurylether, ethyltetrahydrofurylether, propyltetrahydrofurylether, butyltetrahydrofurylether, hexyltetrahydrofurylether, octyltetrahydrofurylether, tetrahydrofuran, 2,2-(bistetrahydrofurfuryl)propane, bistetrahydrofurfurylformal, methyl ether of tetrahydrofurfuryl alcohol, ethyl ether of tetrahydrofurfuryl alcohol, butyl ether of tetrahydrofurfuryl alcohol, α-methoxytetrahydrofuran, dimethoxybenzene and dimethoxyethane, and tertiary amine compounds, such as triethylamine, pyridine, N,N,N′,N′-tetramethyl ethylenediamine, dipiperidinoethane, methyl ether of N,N-diethylethanolamine, ethyl ether of N,N-diethylethanolamine and N,N-diethylethanolamine. Examples of preferred randomizer compounds are identified in WO 2009/148932, incorporated herein by reference in its entirety. The randomizer agent(s) will typically be added at a molar ratio of randomizer compound to initiator compound of from 0.012:1 to 10:1, preferably from 0.1:1 to 8:1 and more preferably from 0.25:1 to about 6:1.

### Coupling Agents

For further controlling polymer molecular weight and polymer properties, a coupling agent (“linking agent”) or a combination of two or more coupling agents can be used. Suitable coupling agents include tin tetrachloride, tin tetrabromide, tin tetrafluoride, tin tetraiodide, silicon tetrachloride, silicon tetrabromide, silicon tetrafluoride, silicon tetraiodide, alkyl tin and alkyl silicon trihalides or dialkyl tin and dialkyl silicon dihalides. Polymers coupled with tin or silicon tetrahalides have a maximum of four arms, polymers coupled with alkyl tin and alkyl silicon trihalides have a maximum of three arms, and polymers coupled with dialkyl tin and dialkyl silicon dihalides have a maximum of two arms. Hexahalo disilanes or hexahalo disiloxanes can also be used as coupling agents resulting in polymers with a maximum of six arms. Useful hexahalo disilanes and disiloxanes include Cl₃Si—SiCl₃, Cl₃Si—O—SiCl₃, Cl₃Sn—SnCl₃ and Cl₃Sn—O—SnCl₃. Further useful examples of tin and silicon coupling agents include Sn(OMe)₄, Si(OMe)₄, Sn(OEt)₄ and Si(OEt)₄. The most preferred coupling agents are SnCl₄, SiCl₄, Sn(OMe)₄ and Si(OMe)₄. Suitable combinations of coupling agents include Bu₂SnCl₂ and SnCl₄; Me₂SiCl₂ and Si(OMe)₄; Me₂SiCl₂ and SiCl₄; SnCl₄ and Si(OMe)₄; and SnCl₄ and SiCl₄.

The coupling agents may be added intermittently (at regular or irregular intervals) or continuously during the polymerization, but are preferably added at a time when the conversion rate of the polymerization has reached 80 wt % or more, and more preferably at a time when the conversion rate has reached 90 wt % or more. For example, a coupling agent can be continuously added during the polymerization, in cases where asymmetrical coupling is desired. This continuous addition is normally done in a reaction zone separate from the zone where the bulk of the polymerization is occurring. The coupling agent can be added to the polymerization mixture in a hydrocarbon solution, for example in cyclohexane, with suitable mixing for distribution and reaction. The polymer coupling reaction may be carried out in a temperature range of from 0° C. to 150° C., preferably from 15° C. to 120° C., and even more preferably from 40° C. to 100° C. There is no limitation for the duration of the coupling reaction. However, with respect to an economical polymerization process, for example in the case of a batch polymerization process, the coupling reaction is usually stopped at about 5 to 60 minutes after the addition of the coupling agent.

Preferably, a substantial proportion of the polymer chain ends is not terminated prior to the reaction with the coupling agent; that is, living polymer chain ends are present and capable of reacting with the coupling agent in a polymer chain coupling reaction. The coupling reaction occurs before, after or during any addition of a chain end-modification agent. Preferably, the coupling reaction is completed prior to any addition of a chain end-modification agent. In one embodiment, as result of the coupling reaction, 80 percent or less, preferably 65 percent or less, more preferably 50 percent or less of the living polymer chains are reacted with the coupling agent.

The total amount of coupling agent used will influence the Mooney viscosity of the coupled polymer and is typically in the range of from 0.01 to 2.0 mol, preferably from 0.02 to 1.5 mol, and more preferably from 0.04 to 0.6 mol of the coupling agent for every 4.0 moles of living and thus anionic polymer chain ends.

It is particularly desirable to utilize a combination of tin and silicon coupling agents in tire tread compounds that contain both silica and carbon black. In such case, the molar ratio of the tin to the silicon compound employed for coupling the elastomeric polymer will normally be within the range of from 20:80 to 95:5; more typically from 40:60 to 90:10, and preferably from 60:40 to 85:15. Most typically, a total amount of from about 0.001 to 4.5 mmol of coupling agent is employed per 100 grams of the elastomeric polymer. It is normally preferred to utilize from about 0.05 to about 0.5 mmol of the coupling agents per 100 grams of polymer to obtain the desired Mooney viscosity and to enable subsequent chain end functionalization of the remaining living polymer fraction. Larger quantities tend to produce polymers containing terminally reactive groups or insufficient coupling and only enable an insufficient chain end modification.

### Accelerator Compounds

The polymerization can optionally include accelerators to increase the reactivity of the initiator (and, thus, to increase the polymerization rate), to randomly arrange aromatic vinyl compounds introduced into the polymer, or to provide a single chain of aromatic vinyl compounds, thus influencing the distribution of aromatic vinyl compounds in a living anionic elastomeric copolymer. A combination of two or more accelerator compounds may be used. Suitable examples of accelerators include sodium alkoxides, sodium phenoxides, potassium alkoxides and potassium phenoxides, preferably potassium alkoxides and potassium phenoxides, such as potassium isopropoxide, potassium t-butoxide, potassium t-amyloxide, potassium n-heptyloxide, potassium benzyloxide, potassium phenoxide; potassium salts of carboxylic acids, such as isovaleric acid, caprylic acid, lauric acid, palmitic acid, stearic acid, oleic acid, linolenic acid, benzoic acid, phthalic acid and 2-ethyl hexanoic acid; potassium salts of organic sulfonic acids, such as dodecyl benzenesulfonic acid, tetradecyl benzenesulfonic acid, hexadecyl benzenesulfonic acid and octadecyl benzenesulfonic acid; and potassium salts of organic phosphorous acids, such as diethyl phosphite, diisopropyl phosphite, diphenyl phosphite, dibutyl phosphite, and dilauryl phosphite. Accelerator compounds may be added in a total amount of from 0.005 to 0.5 mol per 1.0 gram atom equivalent of initiator. If less than 0.005 mol is added, a sufficient effect may not be achieved. On the other hand, if the amount of the accelerator compound is more than about 0.5 mol, the productivity and efficiency of the chain end modification reaction can be significantly reduced.

### Termination Agent

A termination agent contains at least one active hydrogen atom which is capable of reacting with the anionic “leaving” polymer chain end and resulting in the protonation of the same. A single termination agent or a combination of two or more may be used in the polymerization process. Suitable termination agents include water, alcohols, amines, mercaptans and organic acids, preferably alcohols and more preferably C1-C4 alcohols.

The termination agents may be added intermittently (at regular or irregular intervals) or continuously during the polymerization, but are preferably added at a time when the conversion rate of the polymerization has reached 80 wt % or more, and more preferably at a time when the conversion rate has reached 90 wt % or more. For example, a termination agent can be continuously added during the polymerization, in cases where a broad molecular weight distribution is desired. The termination agent can be added undiluted to the polymerization mixture or dissolved in a hydrocarbon solvent, for example in cyclohexane.

### Backbone Modification

The silane modifier of Formula 1 may be added intermittently (at regular or irregular intervals) or continuously during the polymerization of the butadiene and optional conjugated diene(s) and aromatic vinyl compound(s), but is preferably added at a time when the conversion rate of the polymerization has reached 80 wt % or more, more preferably at a time when the conversion rate has reached 90 wt % or more. Preferably, the majority of the polymer chain ends, especially at least 80%, preferably at least 90%, are terminated prior to the addition of the backbone modifier; that is, living polymer chain ends are not present and are not capable of reacting with the backbone modifier in a polymer chain end modification reaction. Termination of the polymer chain ends can be effected by the action of a coupling agent or termination agent, by chain-end functionalization or by other means, such as impurities in the polymerization process or by inter- or intra-chain reactions. The addition of the backbone modifier may be carried out before, after, or during the addition of a coupling agent (if used), and before, after, or during the addition of a chain end modifier (if used), and before, after, or during the addition of a termination agent (if used). Preferably, the backbone modifier is added after any addition of the coupling agent, the chain end modifier and the termination agent. In some embodiments, more than a third of the living polymer chain ends are reacted with a coupling agent, followed by the addition of and reaction with a chain end modifier and prior to the addition of the backbone modifier.

The backbone modifier may be directly added to the polymer solution (polymerization solution) without dilution (neat); however, it may be beneficial to add the backbone modifier in solution, such as in an inert solvent (for example cyclohexane). The amount of backbone modifier added to the polymerization varies depending upon the monomer species, backbone modifier species, reaction conditions and desired end properties, but is generally from 0.001 to 5 weight percentage, preferably from 0.01 to 3 weight percentage and most preferably from 0.05 to 2 weight percentage, based on the weight of the polymer (i.e. unmodified polymer (homopolymer or copolymer) without any solvent, oil, filler and water). The backbone modification (hydrosilylation) may be carried out in a temperature range of from 0° C. to 150° C., preferably from 15° C. to 100° C., and even more preferably from 25° C. to 80° C. There is generally no limitation for the duration and timing of the functionalization reaction. The polymer will be reacted with the silane modifier for a suitable period of time, as will be readily established by a person of ordinary skill in the art, typically ranging from a few seconds to 48 hours, or up to 24 hours, preferably up to 12 hours, more preferably up to 4 hours, or up to 2 hours. The hydrosilylation reaction between the polymer and the silane modifier can take place partially or completely after the addition of the silane modifier to the polymer solution, during the polymer work-up process, in the course of the polymer compounding, or in the polymer compound vulcanization process. It is however essential to distribute the silane modifier compound in the polymer solution prior to the polymer work-up.

The hydrosilylation reaction can be carried out as is known in the art and will usually be performed in the presence of a hydrosilylation catalyst. Preferably, as is known in the art, the catalyst is a transition metal or transition metal compound, more preferably platinum or rhodium or a platinum or rhodium compound. Two or more catalyst compounds may be used in combination. Typical examples of platinum catalysts are platinum black, chloroplatinic acid, olefin complexes of chloroplatinic acid, preferably Karstedt's catalyst or chloroplatinic acid modified with an alcohol. Examples of rhodium-based catalysts include RhCl(PPh₃)₃, RhCl(CO)(PPh₃)₂, RhH(CO)(PPh₃)₃ and olefin complexes of Rh(I) chloride (for example with ethylene or 1,5-cyclooctadiene). The catalyst may be added before, after or simultaneously with the addition of the silane modifier. Preferably, the hydrosilylation catalyst is added together with the silane modifier. The total amount of hydrosilylation catalyst will depend on the amount of silane modifier added but is generally from 0.001 to 5 mol %, preferably from 0.005 to 2 mol % and more preferably from 0.01 to 1 mol %, relative to the molar amount of silane modifier. At lower amounts of the hydrosilylation catalyst, the conversion of the silane modifier may be too low, and higher amounts thereof may be economically disadvantageous.

### Modified Polymer

The modified elastomeric polymer of the present invention is the reaction product of a homopolymer or copolymer as defined above and a silane modifier of Formula 1.

Generally, the addition of a silane compound containing at least one hydrogen atom directly bonded to a silicon atom to a polymer based on a conjugated diene and containing pendant ethylenically unsaturated groups resulting from the 1,2-addition of the conjugated diene predominantly leads to the hydrosilylation of said unsaturated groups. Therefore, the hydrosilylation reaction between an elastomeric polymer containing 1,2-added conjugated diene units and a silane modifier according to Formula 1 is believed to result in a backbone-modified elastomeric polymer having structural groups of the following Formula 11-a or 11-b

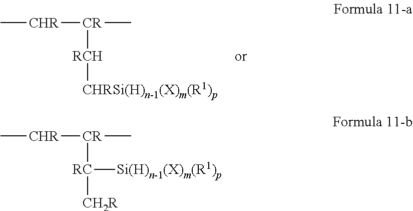

wherein R¹, X, n, m, p are as defined herein and R is independently selected from H and C1-C5 alkyl (depending on the conjugated diene used).

In a preferred version the hydrosilylation reaction takes place between vinyl groups of the elastomeric polymer and a silane modifier according to Formula 1 and it is believed to result in structural groups of the following Formula 11-c or 11-d

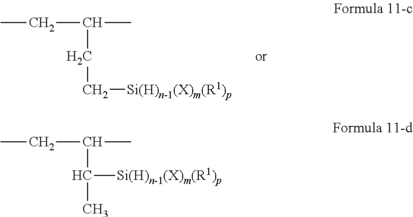

wherein R¹, X, n, m, p are as defined herein.

A 1,2-vinyl group content of less than 20% in the homopolymer or polybutadiene fraction of the copolymer leads to a decrease in the yield of the hydrosilylation reaction.

### Chain End-Modifying Agents and Chain End Modification

For further control of polymer properties, one or more chain end-modifying agents can be employed. Particularly suitable chain end-modifying agents and methods for preparing and making use of the same include those disclosed in PCT/EP2012/068120, WO 2007/047943, WO 2008/032417, WO 2009/148932 and U.S. Pat. No. 6,229,036, JP 2000-230082 and WO 2011/042507, each of which is fully incorporated herein by reference.

Preferred chain end-modifying agents are those of the following Formula 2:

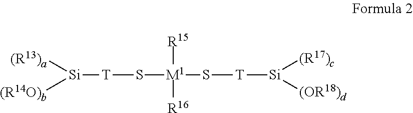

wherein
M¹ is a silicon atom or a tin atom;
T is at least divalent and is (C6-C18) aryl, (C7-C18) alkylaryl, or (C1-C18) alkyl, and each group may be substituted with one or more of the following groups: amine group, silyl group, (C7-C18) aralkyl group and (C6-C18) aryl group;
R¹⁴ and R¹⁸ are each independently selected from (C1-C4) alkyl;
R¹³, R¹⁵, R¹⁶ and R¹⁷ are the same or different and are each independently selected from (C1-C18) alkyl, (C6-C18) aryl and (C7-C18) aralkyl;
a and c are each independently selected from an integer of 0, 1 and 2; b and d are each independently selected from an integer of 1, 2 and 3 and the sum of a and b is 3 (a+b=3); and
the sum of c and d is 3 (c+d=3).

The chain end-modifying agents disclosed and claimed in WO 2007/047943 are particularly preferred for use in the present invention, namely those of the following Formula 3:

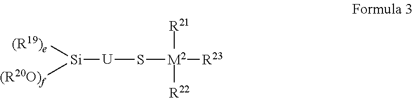

wherein
M² a silicon atom or a tin atom;
U is at least divalent and is (C6-C18) aryl, (C7-C18) alkylaryl or (C1-C18) alkyl, and each group may be substituted with one or more selected from an amine group, silyl group, (C7-C18) aralkyl group and (C6-C18) aryl group;
R¹⁹ is independently selected from (C1-C18) alkyl, (C1-C18) alkoxy, (C6-C18) aryl, (C7-C18) aralkyl and R²⁴—(C₂H₄O)_{g}—O—, wherein R²⁴ is independently selected from (C5-C23) alkyl, (C5-C23) alkoxy, (C6-C18) aryl and (C7-C25) aralkyl and g is an integer selected from 4, 5 and 6;
R²⁰ is independently selected from (C1-C4) alkyl, (C6-C18) aryl and (C7-C18) aralkyl;
R²¹, R²² and R²³ are each independently selected from (C1-C18) alkyl, (C1-C18) alkoxy, (C6-C18) aryl and (C7-C18) aralkyl;
e is an integer selected from 0, 1 or 2; f is an integer selected from 1, 2 or 3; and e+f=3.

Specific preferred species of the chain end-modifying agent of Formula 3 include, but are not limited to:

(MeO)₃Si—(CH₂)₃—S—SiMe₃, (EtO)₃Si—(CH₂)₃—S—SiMe₃, (PrO)₃Si—(CH₂)₃—S—SiMe₃, (BuO)₃Si—(CH₂)₃—S—SiMe₃, (MeO)₃Si—(CH₂)₂—S—SiMe₃, (EtO)₃Si—(CH₂)₂—S—SiMe₃, (PrO)₃Si—(CH₂)₂—S—SiMe₃, (BuO)₃Si—(CH₂)₂—S—SiMe₃, (MeO)₃Si—CH₂—S—SiMe₃, (EtO)₃Si—CH₂—S—SiMe₃, (PrO)₃Si—CH₂—S—SiMe₃, (BuO)₃Si—CH₂—S—SiMe₃, (MeO)₃Si—CH₂—CMe₂-CH₂—S—SiMe₃, (EtO)₃Si—CH₂—CMe₂-CH₂—S—SiMe₃, (PrO)₃Si—CH₂—CMe₂-CH₂—S—SiMe₃, (BuO)₃Si—CH₂—CMe₂-CH₂—S—SiMe₃, ((MeO)₃Si—CH₂—C(H)Me-CH₂—S—SiMe₃, (EtO)₃Si—CH₂—C(H)Me-CH₂—S—SiMe₃, (PrO)₃Si—CH₂—C(H)Me-CH₂—S—SiMe₃, (BuO)₃Si—CH₂—C(H)Me-CH₂—S—SiMe₃, (MeO)₂(Me)Si—(CH₂)₃—S—SiMe₃, (EtO)₂(Me)Si—(CH₂)₃—S—SiMe₃, (PrO)₂(Me)Si—(CH₂)₃—S—SiMe₃, (BuO)₂(Me)Si—(CH₂)₃—S—SiMe₃, (MeO)₂(Me)Si—(CH₂)₂—S—SiMe₃, (EtO)₂(Me)Si—(CH₂)₂—S—SiMe₃, (PrO)₂(Me)Si—(CH₂)₂—S—SiMe₃, (BuO)₂(Me)Si—(CH₂)₂—S—SiMe₃, (MeO)₂(Me)Si—CH₂—S—SiMe₃, (EtO)₂(Me)Si—CH₂—S—SiMe₃, (PrO)₂(Me)Si—CH₂—S—SiMe₃, (BuO)₂(Me)Si—CH₂—S—SiMe₃, (MeO)₂(Me)Si—CH₂—CMe₂-CH₂—S—SiMe₃, (EtO)₂(Me)Si—CH₂—CMe₂-CH₂—S—SiMe₃, (PrO)₂(Me)Si—CH₂—CMe₂-CH₂—S—SiMe₃, (BuO)₂(Me)Si—CH₂—CMe₂-CH₂—S—SiMe₃, ((MeO)₂(Me)Si—CH₂—C(H)Me-CH₂—S—SiMe₃, (EtO)₂(Me)Si—CH₂—C(H)Me-CH₂—S—SiMe₃, (PrO)₂(Me)Si—CH₂—C(H)Me-CH₂—S—SiMe₃, (BuO)₂(Me)Si—CH₂—C(H)Me-CH₂—S—SiMe₃, (MeO) (Me)₂Si—(CH₂)₃—S—SiMe₃, (EtO) (Me)₂Si—(CH₂)₃—S—SiMe₃, (PrO) Me)₂Si—(CH₂)₃—S—SiMe₃, (BuO) (Me)₂Si—(CH₂)₃—S—SiMe₃, (MeO) (Me)₂Si—(CH₂)₂—S—SiMe₃, (EtO) (Me)₂Si—(CH₂)₂—S—SiMe₃, (PrO) (Me)₂Si—(CH₂)₂—S—SiMe₃, (BuO) (Me)₂Si—(CH₂)₂—S—SiMe₃, (MeO) (Me)₂Si—CH₂—S—SiMe₃, (EtO) (Me)₂Si—CH₂—S—SiMe₃, (PrO) (Me)₂Si—CH₂—S—SiMe₃, (BuO) (Me)₂Si—CH₂—S—SiMe₃, (MeO) (Me)₂Si—CH₂—CMe₂-CH₂—S—SiMe₃, (EtO) (Me)₂Si—CH₂—CMe₂-CH₂—S—SiMe₃, (PrO) (Me)₂Si—CH₂—CMe₂-CH₂—S—SiMe₃, (BuO) (Me)₂Si—CH₂—CMe₂-CH₂—S—SiMe₃, ((MeO) (Me)₂Si—CH₂—C(H)Me-CH₂—S—SiMe₃, (EtO) (Me)₂Si—CH₂—C(H)Me-CH₂—S—SiMe₃, (PrO) (Me)₂Si—CH₂—C(H)Me-CH₂—S—SiMe₃, (BuO) (Me)₂Si—CH₂—C(H)Me-CH₂—S—SiMe₃, (MeO)₃Si—(CH₂)₃—S—SiEt₃, (EtO)₃Si—(CH₂)₃—S—SiEt₃, (PrO)₃Si—(CH₂)₃—S—SiEt₃, (BuO)₃Si—(CH₂)₃—S—SiEt₃, (MeO)₃Si—(CH₂)₂—S—SiEt₃, (EtO)₃Si—(CH₂)₂—S—SiEt₃, (PrO)₃Si—(CH₂)₂—S—SiEt₃, (BuO)₃Si—(CH₂)₂—S—SiEt₃, (MeO)₃Si—CH₂—S—SiEt₃, (EtO)₃Si—CH₂—S—SiEt₃, (PrO)₃Si—CH₂—S—SiEt₃, (BuO)₃Si—CH₂—S—SiEt₃, (MeO)₃Si—CH₂—CMe₂-CH₂—S—SiEt₃, (EtO)₃Si—CH₂—CMe₂-CH₂—S—SiEt₃, (PrO)₃Si—CH₂—CMe₂-CH₂—S—SiEt₃, (BuO)₃Si—CH₂—CMe₂-CH₂—S—SiEt₃, ((MeO)₃Si—CH₂—C(H)Me-CH₂—S—SiEt₃, (EtO)₃Si—CH₂—C(H)Me-CH₂—S—SiEt₃, (PrO)₃Si—CH₂—C(H)Me-CH₂—S—SiEt₃, (BuO)₃Si—CH₂—C(H)Me-CH₂—S—SiEt₃, (MeO)₂(Me)Si—(CH₂)₃—S—SiEt₃, (EtO)₂(Me)Si—(CH₂)₃—S—SiEt₃, (PrO)₂(Me)Si—(CH₂)₃—S—SiEt₃, (BuO)₂(Me)Si—(CH₂)₃—S—SiEt₃, (MeO)₂(Me)Si—(CH₂)₂—S—SiEt₃, (EtO)₂(Me)Si—(CH₂)₂—S—SiEt₃, (PrO)₂(Me)Si—(CH₂)₂—S—SiEt₃, (BuO)₂(Me)Si—(CH₂)₂—S—SiEt₃, (MeO)₂(Me)Si—CH₂—S—SiEt₃, (EtO)₂(Me)Si—CH₂—S—SiEt₃, (PrO)₂(Me)Si—CH₂—S—SiEt₃, (BuO)₂(Me)Si—CH₂—S—SiEt₃, (MeO)₂(Me)Si—CH₂—CMe₂-CH₂—S—SiEt₃, (EtO)₂(Me)Si—CH₂—CMe₂-CH₂—S—SiEt₃, (PrO)₂(Me)Si—CH₂—CMe₂-CH₂—S—SiEt₃, (BuO)₂(Me)Si—CH₂—CMe₂-CH₂—S—SiEt₃, ((MeO)₂(Me)Si—CH₂—C(H)Me-CH₂—S—SiEt₃, (EtO)₂(Me)Si—CH₂—C(H)Me-CH₂—S—SiEt₃, (PrO)₂(Me)Si—CH₂—C(H)Me-CH₂—S—SiEt₃, (BuO)₂(Me)Si—CH₂—C(H)Me-CH₂—S—SiEt₃, (MeO) (Me)₂Si—(CH₂)₃—S—SiEt₃, (EtO) (Me)₂Si—(CH₂)₃—S—SiEt₃, (PrO) Me)₂Si—(CH₂)₃—S—SiEt₃, (BuO) (Me)₂Si—(CH₂)₃—S—SiEt₃, (MeO) (Me)₂Si—(CH₂)₂—S—SiEt₃, (EtO) (Me)₂Si—(CH₂)₂—S—SiEt₃, (PrO) (Me)₂Si—(CH₂)₂—S—SiEt₃, (BuO) (Me)₂Si—(CH₂)₂—S—SiEt₃, (MeO) (Me)₂Si—CH₂—S—SiEt₃, (EtO) (Me)₂Si—CH₂—S—SiEt₃, (PrO) (Me)₂Si—CH₂—S—SiEt₃, (BuO) (Me)₂Si—CH₂—S—SiEt₃, (MeO) (Me)₂Si—CH₂—CMe₂-CH₂—S—SiEt₃, (EtO) (Me)₂Si—CH₂—CMe₂-CH₂—S—SiEt₃, (PrO) (Me)₂Si—CH₂—CMe₂-CH₂—S—SiEt₃, (BuO) (Me)₂Si—CH₂—CMe₂-CH₂—S—SiEt₃, ((MeO) (Me)₂Si—CH₂—C(H)Me-CH₂—S—SiEt₃, (EtO) (Me)₂Si—CH₂—C(H)Me-CH₂—S—SiEt₃, (PrO) (Me)₂Si—CH₂—C(H)Me-CH₂—S—SiEt₃, (BuO) (Me)₂Si—CH₂—C(H)Me-CH₂—S—SiEt₃, (MeO)₃Si—(CH₂)₃—S—SiMe₂^{t}Bu, (EtO)₃Si—(CH₂)₃—S—SiMe₂^{t}Bu, (PrO)₃Si—(CH₂)₃—S—SiMe₂^{t}Bu, (BuO)₃Si—(CH₂)₃—S—SiMe₂^{t}Bu, (MeO)₃Si—(CH₂)₂—S—SiMe₂^{t}Bu, (EtO)₃Si—(CH₂)₂—S—SiMe₂^{t}Bu, (PrO)₃Si—(CH₂)₂—S—SiMe₂^{t}Bu, (BuO)₃Si—(CH₂)₂—S—SiMe₂^{t}Bu, (MeO)₃Si—CH₂—S—SiMe₂^{t}Bu, (EtO)₃Si—CH₂—S—SiMe₂^{t}Bu, (PrO)₃Si—CH₂—S—SiMe₂^{t}Bu, (BuO)₃Si—CH₂—S—SiMe₂^{t}Bu, (MeO)₃Si—CH₂—CMe₂-CH₂—S—SiMe₂^{t}Bu, (EtO)₃Si—CH₂—CMe₂-CH₂—S—SiMe₂^{t}Bu, (PrO)₃Si—CH₂—CMe₂-CH₂—S—SiMe₂^{t}Bu, (BuO)₃Si—CH₂—CMe₂-CH₂—S—SiMe₂^{t}Bu, (MeO)₃Si—CH₂—C(H)Me-CH₂—S—SiMe₂^{t}Bu, (EtO)₃Si—CH₂—C(H)Me-CH₂—S—SiMe₂^{t}Bu, (PrO)₃Si—CH₂—C(H)Me-CH₂—S—SiMe₂^{t}Bu, (BuO)₃Si—CH₂—C(H)Me-CH₂—S—SiMe₂^{t}Bu, (MeO)₂(Me)Si—(CH₂)₃—S—SiMe₂^{t}Bu, (EtO)₂(Me)Si—(CH₂)₃—S—SiMe₂^{t}Bu, (PrO)₂(Me)Si—(CH₂)₃—S—SiMe₂^{t}Bu, (BuO)₂(Me)Si—(CH₂)₃—S—SiMe₂^{t}Bu, (MeO)₂(Me)Si—(CH₂)₂—S—SiMe₂^{t}Bu, (EtO)₂(Me)Si—(CH₂)₂—S—SiMe₂^{t}Bu, (PrO)₂(Me)Si—(CH₂)₂—S—SiMe₂^{t}Bu, (BuO)₂(Me)Si—(CH₂)₂—S—SiMe₂^{t}Bu, (MeO)₂(Me)Si—CH₂—S—SiMe₂^{t}Bu, (EtO)₂(Me)Si—CH₂—S—SiMe₂^{t}Bu, (PrO)₂(Me)Si—CH₂—S—SiMe₂^{t}Bu, (BuO)₂(Me)Si—CH₂—S—SiMe₂^{t}Bu, (MeO)₂(Me)Si—CH₂—CMe₂-CH₂—S—SiMe₂^{t}Bu, (EtO)₂(Me)Si—CH₂—CMe₂-CH₂—S—SiMe₂^{t}Bu, (PrO)₂(Me)Si—CH₂—CMe₂-CH₂—S—SiMe₂^{t}Bu, (BuO)₂(Me)Si—CH₂—CMe₂-CH₂—S—SiMe₂^{t}Bu, (MeO)₂(Me) Si—CH₂—C(H)Me-CH₂—S—SiMe₂^{t}Bu, (EtO)₂(Me)Si—CH₂—C(H)Me-CH₂—S—SiMe₂^{t}Bu, (PrO)₂(Me)Si—CH₂—C(H)Me-CH₂—S—SiMe₂^{t}Bu, (BuO)₂(Me)Si—CH₂—C(H)Me-CH₂—S—SiMe₂^{t}Bu, (MeO) (Me)₂Si—(CH₂)₃—S—SiMe₂^{t}Bu, (EtO) (Me)₂Si—(CH₂)₃—S—SiMe₂^{t}Bu, (PrO)(Me)₂Si—(CH₂)₃—S—SiMe₂^{t}Bu, (BuO)(Me)₂Si—(CH₂)₃—S—SiMe₂^{t}Bu, (MeO) (Me)₂Si—(CH₂)₂—S—SiMe₂^{t}Bu, (EtO)(Me)₂Si—(CH₂)₂—S—SiMe₂^{t}Bu, (PrO)(Me)₂Si—(CH₂)₂—S—SiMe₂^{t}Bu, (BuO)(Me)₂Si—(CH₂)₂—S—SiMe₂^{t}Bu, (MeO)(Me)₂Si—CH₂—S—SiMe₂^{t}Bu, (EtO)(Me)₂Si—CH₂—S—SiMe₂^{t}Bu, (PrO)(Me)₂Si—CH₂—S—SiMe₂^{t}Bu, (BuO)(Me)₂Si—CH₂—S—SiMe₂^{t}Bu, (MeO)(Me)₂Si—CH₂—CMe₂-CH₂—S—SiMe₂^{t}Bu, (EtO)(Me)₂Si—CH₂—CMe₂-CH₂—S—SiMe₂^{t}Bu, (PrO) (Me)₂Si—CH₂—CMe₂-CH₂—S—SiMe₂^{t}Bu, (BuO)(Me)₂Si—CH₂—CMe₂-CH₂—S—SiMe₂^{t}Bu, (MeO)(Me)₂Si—CH₂—C(H)Me-CH₂—S—SiMe₂^{t}Bu, (EtO)(Me)₂Si—CH₂—C(H)Me-CH₂—S—SiMe₂^{t}Bu and (PrO)(Me)₂Si—CH₂—C(H)Me-CH₂—S—SiMe₂^{t}Bu.

The chain end-modifying agents may be added intermittently (at regular or irregular intervals) or continuously during the polymerization, but are preferably added at a time when the conversion rate of the polymerization has reached 80 wt % or more, and more preferably at a time when the conversion rate has reached 90 wt % or more. Preferably, a substantial amount of the polymer chain ends is not terminated prior to the reaction with the chain end-modifying agent; that is, the living polymer chain ends are present, and capable of reacting with the end-modifying agent. The chain end modification reaction may occur before, after or during the addition of the coupling agent. Preferably the chain end modification reaction is completed after the addition of the coupling agent. See, for example, WO 2009/148932, incorporated herein by reference.

In one embodiment, more than 20 percent, preferably more than 35 percent, and even more preferably more than 50 percent of the polymer chains, as determined by GPC, formed in the course of the polymerization process, are reacted with a chain end-modifying agent in the process of polymer chain end modification.

In one embodiment, more than 20 percent, preferably more than 35 percent, even more preferably more than 50 percent, and preferably up to 80 percent of the polymer chain ends, as determined by GPC, are reacted with coupling agent(s), prior to the addition of the chain end-modifying agent(s).

In one embodiment, more than 50 percent, preferably more than 60 percent, and more preferably more than 75 percent, as determined by GPC, of the alpha-modified living polymer macromolecules (still remaining after the coupling reaction) react with a chain end-modifying agent.

The chain end-modifying agent may be directly added to the polymer solution without dilution; however, it may be beneficial to add the agent in dissolved form, such as in an inert solvent (e.g. cyclohexane). The amount of chain end-modifying agent added to the polymerization will be adjusted depending on the monomer species, coupling agent, type of chain end-modifying agent, reaction conditions and desired product properties, but is generally from 0.05 to 5 mol-equivalent, preferably from 0.1 to 2.0 mol-equivalent, and most preferably from 0.2 to 1.5 mol-equivalent, per mol equivalent of alkali metal in the initiator compound. The chain end modification reaction may be carried out in a temperature range of from 0° C. to 150° C., preferably of from 15° C. to 120° C., and even more preferably of from 25° C. to 100° C. There is no limitation for the duration of the chain end-modification reaction. However, with respect to an economical polymerization process, for example in the case of a batch polymerization process, the chain end modification reaction is usually stopped at about 5 to 60 minutes after the addition of the modifier.

### Non-Cured Polymer Composition—Reactive Compounding

The non-cured polymer composition of the third aspect of the present invention comprises the modified elastomeric polymer of the invention and one or more further components selected from (i) components which are added to or formed as a result of the polymerization process and/or backbone modification process used for making said polymer, (ii) components which remain after solvent removal from the polymerization and/or backbone modification process, and (iii) components which are added to the polymer after completion of the polymerization and/or backbone modification process, thus including components which are added to the “solvent-free” polymer, such as by using a mechanical mixer. In a preferred embodiment, the non-cured polymer composition comprises the modified elastomeric polymer of the invention and one or more fillers, more preferably it comprises the modified elastomeric polymer of the invention and one or more fillers and one or more extender oils.

In the polymer composition of the invention, the modified elastomeric polymer of the invention preferably constitutes at least 15% by weight of the total polymer present, more preferably at least 25% by weight and even more preferably at least 35% by weight. The remaining portion of the polymer is unmodified elastomeric polymer or polymer not modified in accordance with the invention. Examples of preferred unmodified elastomeric polymers are itemized in WO 2009/148932 and preferably include styrene-butadiene copolymer, natural rubbers, polyisoprene and polybutadiene. It is desirable that the unmodified polymers have a Mooney viscosity (ML 1+4, 100° C. as measured in accordance with ASTM D 1646 (2004), as discussed above) in the range of from 20 to 200, preferably from 25 to 150.

In the polymer composition of the invention, the modified elastomeric polymer of the invention preferably constitutes at least 5% by weight of the total composition, more preferably at least 10% by weight and even more preferably at least 15% by weight.

In one embodiment, the non-cured (non-crosslinked or unvulcanized) polymer composition is obtained by conventional work-up of the reaction mixture obtained in the polymerization and/or backbone modification process. Work-up means the removal of the solvent using steam stripping or vacuum evaporation techniques.

In another embodiment, the non-cured polymer composition of the invention is obtained as a result of a further mechanical mixing process involving the worked-up reaction mixture (including the polymer of the invention), preferably in the form of a rubber bale (i.e. the product of a conventional compounding process in an internal mixer and/or by means of a two-roll mill), and at least one filler. Further details are described in F. Röthemeyer, F. Sommer, Kautschuk Technologie: Werkstoffe—Verarbeitung—Produkte, 3rd ed., (Hanser Verlag, 2013) and references cited therein.

The following components as examples of the above components (i), (ii) and (iii) are usually employed in non-cured compositions for use in tires: fillers, extender oils, processing aids, silane coupling agents, stabilizers, further polymers, vulcanizing agents.

### Fillers

In a preferred embodiment, the modified elastomeric polymer of the invention is combined and reacted with one or more fillers. Fillers serve as reinforcement agents in the polymer composition and may be selected from carbon black, silica, carbon-silica dual phase filler, carbon nanotubes, calcium carbonate, magnesium carbonate, lignin, amorphous fillers such as glass particle-based filler, clay (layered silicates) such as magadiite, and starch-based fillers.

Examples of fillers are described in WO 2009/148932, fully incorporated herein by reference. Specific embodiments for use in the present invention are: a combination of carbon black and silica; carbon-silica dual phase filler alone or in combination with carbon black and/or silica.

Carbon black is conventionally manufactured by a furnace method, and in some embodiments carbon black with a nitrogen adsorption (N2A) specific surface area of 50-200 m²/g, preferably 60-150 m²/g, and DBP oil absorption of 80-200 ml/100 grams, for example FEF; HAF, ISAF, or SAF class carbon black, is used. A lower N2A value may result in a reduced reinforcing effect, whereas a higher N2A value may lead to increased hysteresis loss and deteriorated processability of the rubber compound. In some embodiments, high agglomeration type carbon black is used. Carbon black is typically added in an amount of from 2 to 100 parts by weight, in some embodiments from 5 to 100 parts by weight, in some embodiments from 10 to 100 parts by weight, and in some embodiments from 10 to 95 parts by weight per 100 parts by weight of the total elastomeric polymer.

Examples of silica fillers include but are not limited to wet process silica, dry process silica, synthetic silicate-type silica and combinations thereof. Silica with a small particle diameter and high surface area exhibits a high reinforcing effect. Small diameter, high agglomeration-type silica (i.e., having a large surface area and high oil absorptivity) exhibits excellent dispersibility in the elastomeric polymer composition, representing desirable properties and superior processability. An average particle diameter of silica, in terms of a primary particle diameter, is in some embodiments from 5 to 60 nm, and in some embodiments from 10 to 35 nm. Moreover, the specific surface area of the silica particles (N2A, measured by the BET method) is in some embodiments from 35 to 300 m²/g. In some embodiments, the silica has a surface area of from 150 to 300 m²/g. Lower N2A values may lead to an unfavorably low reinforcing effect, whereas higher N2A values may provide a rubber compound with an increased viscosity and a deteriorated processability. For examples of suitable silica filler diameters, particle sizes and BET surface areas, see WO 2009/148932. Silica is added in an amount of from 10 to 100 parts by weight, in some embodiments from 30 to 100 parts by weight, and in some embodiments from 30 to 95 parts by weight for 100 parts by weight of the total elastomeric polymer.

Carbon black and silica may be added together, in which case the total amount of carbon black and silica is from 30 to 100 parts by weight and, in some embodiments, from 30 to 95 parts by weight per 100 parts by weight of the total elastomeric polymer. As long as such fillers are homogeneously dispersed in the elastomeric composition, increasing quantities (within the above ranges) result in compositions having excellent rolling and extruding processability and vulcanized products exhibiting favorable hysteresis loss properties, rolling resistance, improved wet skid resistance, abrasion resistance and tensile strength.

Carbon-silica dual phase filler may be used either independently or in combination with carbon black and/or silica in accordance with the present teachings. Carbon-silica dual phase filler can exhibit the same effects as those obtained by the combined use of carbon black and silica, even in the case where it is added alone. Carbon-silica dual phase filler is so-called silica-coated carbon black made by coating silica on the surface of carbon black, and is commercially available under the trademark CRX2000, CRX2002 or CRX2006 (products of Cabot Co.). Carbon-silica dual phase filler is added in the same amounts as described above with respect to silica. Carbon-silica dual phase filler can be used in combinations with other fillers including but not limited to carbon black, silica, clay, calcium carbonate, carbon nanotubes, magnesium carbonate and combinations thereof. In some embodiments, carbon black and silica, either individually or in combination, are used.

### Extender Oils

Oils (also referred to as extender oils) may be used with the modified elastomeric polymers to reduce viscosity or Mooney values, or to improve processability of the modified elastomeric polymer as well as various performance properties of (vulcanized) compositions.

For representative examples and classification of suitable oils see WO 2009/148932 and U.S. 2005/0159513, each of which is incorporated herein by reference in its entirety.

Representative oils include but are not limited to MES (Mild Extraction Solvate), TDAE (Treated Distillate Aromatic Extract), RAE (Residual Aromatic Extract) including but not limited to T-RAE and S-RAE, DAE including T-DAE and NAP (light and heavy naphthenic oils), such as Nytex 4700, Nytex 8450, Nytex 5450, Nytex 832, Tufflo 2000, and Tufflo 1200. In addition, native oils, including but not limited to vegetable oils, can be used as extender oils. Representative oils also include functionalized variations of the aforementioned oils, particularly epoxidized or hydroxylated oils. The aforementioned oils contain varying concentrations of polycyclic aromatic compounds, paraffinics, naphthenics and aromatics and have different glass transition temperatures. For a characterization of these types of oils see Kautschuk Gummi Kunststoffe, vol. 52, pages 799-805.

### Processing Aids

Processing aids can optionally be added to a polymer composition of the present invention. Processing aids are usually added to reduce the polymer composition viscosity. As a result, the mixing period is decreased and/or the number of mixing steps is reduced and, consequently, less energy is consumed and/or a higher throughput in the course of the rubber compound extrusion process is achieved. Representative suitable processing aids are described in Rubber Handbook, SGP, The Swedish Institution of Rubber Technology 2000 and in Werner Kleemann, Kurt Weber, Elastverarbeitung-Kennwerte and Berechnungsmethoden, Deutscher Verlag für Grundstoffindustrie (Leipzig, 1990), each of which is incorporated herein by reference in its entirety. Processing aids can be classified as follows:

(A) fatty acids including but not limited to oleic acid, priolene, pristerene and stearic acid;
(B) fatty acid salts including but not limited to Aktiplast GT, PP, ST, T, T-60, 8, F; Deoflow S; Kettlitz Dispergator FL, FL Plus; Dispergum 18, C, E, K, L, N, T, R; Polyplastol 6, 15, 19, 21, 23; Struktol A50P, A60, EF44, EF66, EM16, EM50, WA48, WB16, WB42, WS180, WS280 and ZEHDL;
(C) dispersing agents and processing aids including but not limited to Aflux 12, 16, 42, 54, 25; Deoflow A, D; Deogum 80; Deosol H; Kettlitz Dispergator DS, KB, OX; Kettlitz-Mediaplast 40, 50, Pertac/GR; Kettlitz-Dispergator SI; Struktol FL and WB 212; and
(D) dispersing agents for highly active white fillers including but not limited to Struktol W33 and WB42.

Bifunctionalized silanes and monofunctional silanes (herein also called “silane coupling agents”) are also occasionally referred to as processing aids but are separately described below.

### Silane Coupling Agents

In some embodiments, one or more silane coupling agents can be used for compatibilization of the modified elastomeric polymer and the filler. The typical total amount of silane coupling agents is from 1 to 20 parts by weight and, in some embodiments, from 5 to 15 parts by weight per 100 parts by weight of the total amount of silica and/or carbon-silica dual phase filler.

Silane coupling agents can be classified as follows, according to Fritz Röthemeyer, Franz Sommer: Kautschuk Technologie, (Carl Hanser Verlag 2006):

(A) bifunctionalized silanes including but not limited to Si 230 (EtO)₃Si(CH₂)₃Cl, Si 225 (EtO)₃SiCH═CH₂, A189 (EtO)₃Si(CH₂)₃SH, [(EtO)₃Si(CH₂)₃Sₓ(CH₂)₃Si(OEt)₃], wherein x=3.75 (Si69) or 2.35 (Si75), Si 264 (EtO)₃Si—(CH₂)₃SCN and Si 363 (EtO)Si((CH₂—CH₂—O)₅(CH₂)₁₂CH₃)₂(CH2)₃SH) (Evonic Industries AG), 3-octanoylthio-1-propyltriethoxysilane; and
(B) monofunctional silanes including but not limited to Si 203 (EtO)₃—Si—C₃H₇, and Si 208 (EtO)₃—Si—C₈H₁₇.

Further examples of silane coupling agents are given in WO 2009/148932 and include but are not limited to bis-(3-hydroxy-dimethylsilyl-propyetetrasulfide, bis-(3-hydroxy-dimethylsilyl-propyl)-disulfide, bis-(2-hydroxy-dimethylsilyl-ethyl)tetrasulfide, bis-(2-hydroxy-dimethyl-silyl-ethyl)disulfide, 3-hydroxy-dimethylsilyl-propyl-N,N-dimethylthiocarbamoyltetrasulfide and 3-hydroxy-dimethylsilyl-propylbenzothiazole tetrasulfide.

### Stabilizers

One or more stabilizers (“antioxidants”) can optionally be added to the polymer prior to or after the termination of the polymerization process to prevent the degradation of the elastomeric polymer by molecular oxygen. Antioxidants based on sterically hindered phenols, such as 2,6-di-tert-butyl-4-methylphenol, 6,6′-methylenebis(2-tert-butyl-4-methylphenol), Iso-octyl-3-(3,5-di-tert-butyl-4-hydroxyphenyl) propionate, hexamethylenebis[3-(3,5-di-tert-butyl-4-hydroxyphenyl)propionate], octadecyl-3-(3,5-di-tert-butyl-4-hydroxyphenyl) propionate, isotridecyl-3-(3,5-di-tert-butyl-4-hydroxyphenyl) propionate, 1,3,5-trimethyl-2,4,6-tris(3,5-di-tert-butyl-4-hydroxybenzyl) benzene, 2,2′-ethylidenebis-(4,6-di-tert-butylphenol), tetrakis[methylene-3-(3,5-di-tert-butyl-4-hydroxyphenyl)propionate]methane, 2-[1-(2-hydroxy-3, 5-di-tert-pentylphenyl)ethyl]-4, 6-di-tert-pentylphenyl acrylate and 2-tert-butyl-6-(3-tert-butyl-2-hydroxy-5-methylbenzyl)-4-methylphenyl acrylate, and antioxidants based on thio-esters, such as 4,6-bis(octylthiomethyl)-o-cresol and pentaerythrityl tetrakis(3-laurylthiopropionate), are typically used. Further examples of suitable stabilizers can be found in F. Röthemeyer, F. Sommer, Kautschuk Technologie, 2^{nd} ed., (Hanser Verlag, 2006) pages 340-344, and references cited therein.

### Further Polymers

Apart from polymer of the invention and optionally extender oil(s), filler(s), etc., the polymer composition of the invention may additionally contain one or more further polymers, especially one or more further elastomeric polymers. Further polymers may be added as solution to a solution of the inventive polymer prior to work up of the polymer blend or may be added during a mechanical mixing process, e.g. in a Brabender mixer.

### Vulcanizing Agents

A non-cured polymer composition of the invention which is to be cured (vulcanized) will additionally contains one or more vulcanizing agents. Sulfur, sulfur-containing compounds acting as sulfur-donors, sulfur-accelerator systems and peroxides are the most common vulcanizing agents. Examples of sulfur-containing compounds acting as sulfur-donors include but are not limited to dithiodimorpholine (DTDM), tetramethylthiuramdisulphide (TMTD), tetraethylthiuramdisulphide (TETD), and dipentamethylenthiuramtetrasulphide (DPTT). Examples of sulfur accelerators include but are not limited to amine derivates, guanidine derivates, aldehydeamine condensation products, thiazoles, thiuram sulphides, dithiocarbamates and thiophosphates. Examples of peroxides used as vulcanizing agents include but are not limited to di-tert.-butyl-peroxides, di-(tert.-butyl-peroxy-trimethyl-cyclohexane), di-(tert.-butyl-peroxy-isopropyl-)benzene, dichloro-benzoylperoxide, dicumylperoxides, tert.-butyl-cumyl-peroxide, dimethyl-di(tert.-butyl-peroxy)hexane, dimethyl-di(tert.-butyl-peroxy)hexine and butyl-di(tert.-butyl-peroxy)valerate (Rubber Handbook, SGF, The Swedish Institution of Rubber Technology 2000). Further examples and additional information regarding vulcanizing agents can be found in Kirk-Othmer, Encyclopedia of Chemical technology 3^{rd}, Ed., (Wiley Interscience, N.Y. 1982), volume 20, pp. 365-468, (specifically “Vulcanizing Agents and Auxiliary Materials” pp. 390-402). Vulcanizing agent is typically added to the polymer composition in a total amount of from 0.5 to 10 parts by weight and, in some embodiments, from 1 to 6 parts by weight per 100 parts by weight of the total elastomeric polymer.

One or more vulcanizing accelerators of the sulfene amide-type, guanidine-type, or thiuram-type can be used together with a vulcanizing agent as needed. Examples of vulcanizing accelerators and the amount of accelerator added with respect to the total polymer are given in WO 2009/148932. Sulfur-accelerator systems may or may not comprise zinc. Zinc oxide (zinc white) is preferably used as a component of a sulfur-accelerator system.

### Vulcanized Polymer Composition

The vulcanized polymer composition of the fourth aspect of the invention is obtained by vulcanizing a non-vulcanized polymer composition of the invention comprising one or more vulcanizing agents, under conditions and with machinery conventionally known in the art.

The cross-linked (vulcanized) polymer compositions exhibit reduced heat build-up, reduced tan δ values at 60° C., higher rebound resilience values at 60° C., higher tan δ at −10° C., and a good balance of physical properties, including one or more of the following: tensile strength, modulus and tear, while compounds comprising the uncrosslinked elastomeric polymers (compounds prior to vulcanization) maintain good processing characteristics. The compositions of the invention are useful in preparing tire treads having lower rolling resistance, higher wet grip, higher ice grip and lower heat built-up, while maintaining good wear properties. The compositions of the invention including fillers such as carbon black, silica, clays, carbon-silica dual phase filler, vulcanizing agents and the like and the vulcanized elastomeric polymer compositions of the invention are particularly useful in the preparation of tires.

### Article Comprising Vulcanized Polymer Composition

Since the vulcanized polymer compositions of the invention exhibit low rolling resistance, low dynamic heat build-up and increased wet grip, they are well suited for use in manufacturing, e.g., tires or parts of tires including for example: tire treads, side walls and tire carcasses as well as other industrial products such as belts, hoses, vibration dampers and footwear components. Thus, the article of the fifth aspect of the present invention comprises at least one component formed from the vulcanized polymer composition of the invention (fourth aspect of the invention). The article may be, for instance, a tire, a tire tread, a tire side wall, a tire carcass, a belt, a gasket, a seal, a hose, a vibration damper, a golf ball or a footwear component, such as a shoe sole.

### DEFINITIONS

1,2-Added butadiene (or “vinyl groups” or “1,2-bonds”) as used herein refers to 1,3-butadiene monomers incorporated in the polymer chain via the first and second carbon atom of the monomer molecule resulting in a vinyl (ethylidene) group pending to the main chain of the polymer. The content of 1,2-added butadiene (or vinyl group content) is expressed as percent (or weight percent) relative to the total amount of butadiene in the polymer. ¹H-NMR-spectroscopy is used to determine the vinyl group content and styrene content. For this purpose, the polymer sample is dissolved in deuterated chloroform and the spectra are obtained using a Bruker 400 MHz spectrometer. Vinyl group content VC refers to the 1,2-polybutadiene contained in the polybutadiene fraction of the polymer.

The term “living anionic elastomeric polymer” as used herein refers to a polymer which has at least one reactive or “living” anionic end group.

Alkyl groups as defined herein, whether as such or in association with other groups, such as alkylaryl or alkoxy, include both straight chain alkyl groups, such as methyl (Me), ethyl (Et), n-propyl (Pr), n-butyl (Bu), n-pentyl, n-hexyl, etc., branched alkyl groups, such as isopropyl, tert-butyl (^{t}Bu), etc., and cyclic alkyl groups, such as cyclohexyl.

Alkoxy groups as defined herein include methoxy (MeO), ethoxy (EtO), propoxy (PrO), butoxy (BuO), isopropoxy, isobutoxy, pentoxy, etc.

Aryl groups as defined herein include phenyl, biphenyl and other benzenoid compounds. Aryl groups preferably contain only one aromatic ring and most preferably contain a C₆ aromatic ring.

Alkylaryl groups as defined herein refer to a combination of one or more aryl groups bonded to one or more alkyl groups, for example in the form of alkyl-aryl, aryl-alkyl, alkyl-aryl-alkyl and aryl-alkyl-aryl. Alkylaryl groups preferably contain only one aromatic ring and most preferably contain a C₆ aromatic ring.

The present invention will be explained in more detail by way of examples, which are not intended to be limiting the present invention.

### EXAMPLES

The following examples are provided in order to further illustrate the invention, and are not to be construed as a limitation of the invention. The examples include the preparation and testing of modified elastomeric polymers; and the preparation and testing of uncrosslinked polymer compositions, as well as of cross-linked or cured polymer compositions, also referred to as vulcanized polymer composition. Unless stated otherwise, all parts and percentages are expressed on weight basis. “Room temperature” refers to a temperature of 20° C. All polymerizations were performed in a nitrogen atmosphere under exclusion of moisture and oxygen.

The vinyl group content in the polybutadiene fraction was established by IR absorption spectroscopy (Morello method, IFS 66 FT-IR spectrometer of Bruker Analytic GmbH), based on a calibration determination with an ¹H-NMR method as described above. The IR samples were prepared using CS₂ as swelling agent.

Bonded styrene content: A calibration curve was prepared by IR absorption spectrum (IR (IFS 66 FT-IR spectrometer of Bruker Analytik GmbH). The IR samples were prepared using CS₂ as swelling agent. For the IR determination of bonded styrene in styrene-butadiene copolymers, four bands are checked: a) band for trans-1,4-polybutadiene units at 966 cm⁻¹, b) band for cis-1,4-polybutadiene units at 730 cm⁻¹, c) band for 1,2-polybutadiene units at 910 cm⁻¹ and d) band for bonded styrene (styrene aromatic bond) at 700 cm⁻¹. The band heights are normalized according to the appropriate extinction coefficients and summarized to a total of 100%. The normalization is done via ¹H- and ¹³C-NMR (Avance 400 of Bruker Analytik GmbH, ¹H=400 MHz; ¹³C=100 MHz).

ICP measurements were performed on an ICP OES Optima 2100 DV from Perkin Elmer. Samples were prepared by a microwave-assisted acid extraction.

GPC-Method: SEC calibrated with narrow distributed polystyrene standard.

### Sample Preparation:

a) About 9-11 mg dried polymer sample (moisture content <0.6%) was dissolved in 10 mL tetrahydrofuran, using a brown vial of 10 mL size. The polymer was dissolved by shaking the vial for 20 min at 200 u/min.
b) Polymer solution was transferred into a 2 ml vial using a 0.45 μm disposable filter.
c) The 2 ml vial was placed on a sampler for GPC-analysis.
Elution rate: 1.00 mL/min
Injection volume: 100.00 μm

Polydispersity (Mw/Mn) was used as a measure for the width of molecular weight distribution. The values of Mw and Mn (weight average molecular weight (Mw) and number average molecular weight (Mn)) were measured by gel permeation chromatography on a SEC with viscosity detection (universal calibration). The measurement was performed in THF at 40° C. Instrument: Agilent Serie 1100/1200; Module setup: Iso pump, autosampler, thermostat, VW—Detector, RI—Detector, Degasser; Columns PL Mixed B/HP Mixed B.

In each GPC-device, 3 columns were used in an connected mode. Length of each column: 300 mm; column type: 79911 GP-MXB, Plgel 10 μm MIXED-B GPC/SEC Columns, Fa. Agilent Technologies

### GPC Standards: EasiCal PS-1 Polystyrene Standards, Spatula A+B

Styrene Standard Manufacturer: Polymer Laboratories, now an entity of Varian, Inc.

The Mp value corresponds to the (maximum peak) molecular weight measured at the peak with highest intensity. Maximum peak molecular weight means the molecular weight of the peak at the position of maximum peak intensity. Mp1, Mp2 and Mp3 correspond to the (maximum peak) molecular weight measured at the first, second and third peak of the GPC curve, respectively (the first peak Mp1 (lowest molecular weight) is located on the right-hand side of the curve, and the last peak (highest molecular weight) is located on the left-hand side of the curve). Maximum peak molecular weight means the molecular weight of the peak at the position of maximum peak intensity. Mp2 and Mp3 are two or three polymer chains coupled to one macromolecule. Mp1 is one polymer chain (base molecular weight—no coupling of two or more polymer chains to one macromolecule).

The total coupling rate represents the sum of the weight fractions of coupled polymers relative to the total polymer weight, including the sum of the weight fractions of all coupled polymers and the uncoupled polymer. The total coupling rate is calculated as follows:

CR(total)=(ΣArea fraction of all coupled peaks [Peak with maximum Mp2 to peak with highest indexed peak maximum])/(ΣArea fraction of all peaks [Peak with peak maximum Mp1 to peak with highest indexed peak maximum]).

Rubber compounds were prepared by combining the component listed below in Table 5 in a 380 ml Banbury mixer (Labstation 350S from Brabender GmbH & Co KG), following a two-stage mixing process. Stage 1—mixed all components together, except the components of the vulcanization package, to form a stage 1 formulation. Stage 2—components of vulcanization package were mixed into stage 1 formulation to form a stage 2 formulation.

Mooney viscosity was measured according to ASTM D 1646 (2004), with a preheating time of one minute and a rotor operation time of 4 minutes, at a temperature of 100° C. [ML1+4(100° C.)], on a MV 2000E from Alpha Technologies UK. The rubber Mooney viscosity measurement is performed on dry (solvent free) raw polymer (unvulcanized rubber). The Mooney values of the raw polymers are listed in Table 6.

Measurement of unvulcanized rheological properties was performed according to ASTM D 5289-95 (reapproved 2001), using a rotor-less shear rheometer (MDR 2000 E from Alpha Technologies UK) to measure Time to Cure (TC). The rheometer measurement was performed at a constant temperature of 160° C. on a non-vulcanized second stage polymer formulation, according to Table 5. The amount of the polymer sample is about 4.5 g. Sample shape and shape preparation are standardized and defined by the measurement device (MDR 2000 E from Alpha Technologies UK).

“TC 50”, “TC 90” and “TC 95” values are the respective times required to achieve 50%, 90% and 95% conversion of the vulcanization reaction. The torque is measured as a function of time of reaction. The vulcanization conversion is automatically calculated from the generated torque versus time curve.

Tensile Strength, Elongation at Break and Modulus at 300% Elongation (Modulus 300) were measured according to ASTM D 412-98A (reapproved 2002), using a dumbbell die C test piece on a Zwick Z010. Standardized dumbbell die C test pieces of 2 mm thickness were used. The tensile strength measurement was performed at room temperature on a cured second stage polymer sample, prepared according to Table 6. Stage 2 formulations were vulcanized within 16-25 minutes at 160° C. to TC 95 (95% vulcanization conversion) (see cure data in Table 6).

Heat build-up was measured according to ASTM D 623, method A, on a Doli ‘Goodrich’-Flexometer. The heat build-up measurement was performed on a vulcanized second stage polymer samples according to Table 6. Stage 2 formulations were vulcanized at 160° C. to TC 95 (95% vulcanization conversion) (see cure data in Table 6).

Rebound resilience was measured according to DIN 53512 at 0° C. and 60° C. on a Zwick 5109. The measurement was performed on a cured second stage polymer sample, prepared according to Table 5. Stage 2 formulations were vulcanized at 160° C. to TC 95 (95% vulcanization conversion) (see cure data in Table 6). The smaller the index at 0° C., the better the wet skid resistance (lower=better). The larger the index at 60° C., the lower the hysteresis loss and lower the rolling resistance (higher=better).

Tan δ at 60° C. and tan δ at 0° C. as well as tan δ at −10° C. measurements were performed on cylindrical specimen, using a dynamic mechanical thermal spectrometer “Eplexor 150N,” manufactured by Gabo Qualimeter Testanlagen GmbH (Germany), by applying a compression dynamic strain of 0.2%, at a frequency of 2 Hz, at the respective temperatures. The smaller the index at a temperature of 60° C., the lower the rolling resistance (lower=better). Tan δ at 0° C. and Tan δ at −10° C. were measured using the same equipment and load conditions at 0° C. and −10° C. The larger the index at 0° C., the better the wet skid resistance and the larger the index at −10° C., the better the ice grip properties (higher=better). Tan δ at 60° C. and tan δ at 0° C. as well as tan δ at −10° C. were determined (see Table 7). Stage 2 formulations were vulcanized at 160° C. to TC 95 (95% vulcanization conversion) (see cure data in Table 6). The process leads to the formation of visually “bubble free,” homogeneous cured rubber disc of “60 mm diameter” and “10 mm height.” A specimen was drilled out of the aforementioned dish and has a size of “10 mm diameter” and “10 mm height.”

In general, the higher the values for Elongation at Break, Tensile Strength, Modulus 300, and tan δ at 0° C., Rebound Resilience at 60° C. the better the sample performance; whereas the lower the tan δ at 60° C., Heat Build Up and Rebound Resilience at 0° C., the better the sample performance.

The following silane modifiers were used: triethoxysilane (S1), trimethoxysilane (S2, purchased from Acros Organics), dimethylsilyldiethylamine (S3) and platinum-divinyltetramethyldisiloxane complex (purchased from ABCR).

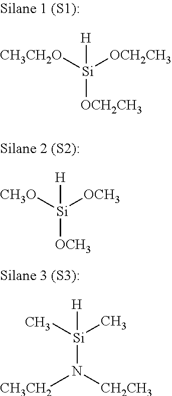

Oligomeric high vinyl bond polybutadiene (vinyl group content 84%) was purchased from Sigma-Aldrich. The polymers SSBR-1 and SSBR-2 are commercial grades from Styron with the trade names Sprintan SLR 4601 and SLR 4602.

Chain End Modifier E1 was prepared as follows:

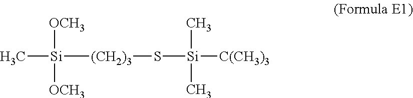

### Preparation Pathway 1 (E1):

To a 100 mL Schlenk flask was charged 25 ml tetrahydrofuran (THF), 79.5 mg (10 mmol) lithium hydride, and subsequently, 1.96 g (10 mmol) gamma-mercaptopropyl trimethoxy silane [Silquest A-189] from the Cromton GmbH. The reaction mixture was stirred for 24 hours at room temperature, and another two hours at 50° C. Than tert-butyl dimethyl chloro silane (1.51 g (10 mmol)) was dissolved in 10 g THF, and the resulting solution was then added drop wise to the Schlenk flask. Lithium chloride precipitated. The suspension was stirred for about 24 hours at room temperature, and for another two hours at 50° C. The THF solvent was removed under vacuum. Then cyclohexane (30 ml) was added. The white precipitate was subsequently separated by filtration. The cyclohexane solvent was removed under vacuum (under reduced pressure). The resulting colorless liquid solution proved to be 99% pure per GC, and therefore no further purification was necessary. A yield of 2.9 g (9.2 mmol) of modified coupling agent (E1) was obtained.

### Alternative Preparation Pathway 2 (E1):

To a 100 mL Schlenk flask was charged 1.96 g (10 mmol) gamma-mercaptopropyl trimethoxy silane [Silquest A-189] from the Cromton GmbH, 25 ml tetrahydrofuran (THF), and subsequently, 0.594 g (11 mmol) sodium methanolate (NaOMe) dissolved in 10 mL THF. The reaction mixture was stirred for 18 hours at room temperature. Then tert-butyl dimethyl chloro silane (1.51 g (10 mmol)) was dissolved in 10 g THF, and the resulting solution was then added drop wise to the Schlenk flask. Sodium chloride precipitated. The suspension was stirred for about 24 hours at room temperature, and for another two hours at 50° C. The THF solvent was removed under vacuum. Then cyclohexane (30 ml) was added. The white precipitate was subsequently separated by filtration. The cyclohexane solvent was removed under vacuum (under reduced pressure). The resulting colorless liquid solution proved to be 89% pure per GC. Further purification consisted in a fractionated distillation, and a yield of 2.2 g (7.2 mmol) of modified coupling agent E1 was obtained.

### Backbone Modification of Oligomeric High Vinyl Polybutadiene (Example O1-O4)

The high vinyl polybutadiene oligomer (0.5 g) was dissolved in 5 mL cyclohexane. Subsequently the silane and platinum-divinyltetramethyldisiloxane complex (solution in xylene, 0.1 mol/L Pt) were added and the mixture was stirred. The amount of reagents, the reaction times and the reaction temperatures are summarized in Table 1. After the desired reaction time, all volatiles were removed under reduced pressure. The Examples O3 and O4 were treated with a mixture of cyclohexane/methanol (3 mL/0.5 mL) for one hour at room temperature to convert the —SiCl₃ groups to —Si(OMe)₃ groups. Further all volatiles were removed under vacuum. The oligomeric residues of the examples O1-O4 were analyzed by NMR to determine the conversion of the hydrosilylation.

TABLE 1
Amounts of reagents and conditions for the hydrosilylation of
polybutadiene oligomer

| Exam- | Silane | Catalyst^{A} | Reaction | Reaction | Conversion^{B} |
|---|---|---|---|---|---|
| ple | (mmol) | [μmol] | time | temperature | [mol %] |
| O1 | S1 (0.91) | 0.92 | 20 h | 60° C. | 100 |
| O2 | S1 (0.45) | 0.45 | 1.5 h | 70° C. | 47 |
| O3 | HSiCl₃ | 0.92 | 20 h | 60° C. | 100 |
| | (0.91) | | | | |
| O4 | HSiCl₃ | 0.45 | 1.5 h | 70° C. | 100 |
| | (0.45) | | | | |

^{A}Amount of Platinum added as Platinum-divinyltetramethyldisiloxane complex
^{B}Calculated from NMR measurements of the hydrosilylated polybutadiene oligomer using the method described by Rempel et al. in Macromolecules vol. 23, pages 5047-5054

### Backbone Modification of SSBR (Examples B1-B3)

To a 2 L glass reactor equipped with a mechanical stirrer was added 56 g of SSBR-1 (Sprintan® SLR 4601). The reactor was filled with 300 g cyclohexane and the polymer was dissolved for 2 hours at 60° C. The polymer solution was transferred to a 1.7 L steel bottle. The bottle was evaporated and filled with nitrogen to remove air. Subsequently triethoxysilane (Si) and platinum-divinyltetramethyldisiloxane complex (solution in xylene, 0.1 mol/L Pt) were added and the bottle was rotated in a water bath for 75 minutes at 65° C. The resulting polymer solution was than stripped with steam for one hour to remove solvent and other volatiles, and dried in an oven at 70° C. for 30 minutes and then additionally for one to three days, at room temperature. Table 2 summarizes the results and amount of reagents for the samples B1-B3.

### Backbone Modification of SSBR (Examples B4-B5)

To a 2 L glass reactor equipped with a mechanical stirrer was added 40 g of SSBR-2 (Sprintan® SLR 4602). The reactor was filled with 210 g cyclohexane and the polymer was dissolved for 2 hours at 60° C. The polymer solution was transferred to a 1.7 L steel bottle. The bottle was evaporated and filled with nitrogen to remove air. Subsequently trimethoxysilane (S2) and platinum-divinyltetramethyldisiloxane complex (solution in xylene, 0.1 mol/L Pt) were added and the bottle was rotated in a water bath for 75 minutes at 65° C. The resulting polymer solution was than stripped with steam for one hour to remove solvent and other volatiles, and dried in an oven at 70° C. for 30 minutes and then additionally for one to three days, at room temperature. Table 2 summarizes the results and amount of reagents for the samples B4 and B5.

TABLE 2
Amount of reagents for hydrosilylation and polymer characterization

| | | Silane/ | | | | |
|---|---|---|---|---|---|---|
| | Silane | Polymer | Pt ^{A} | | Si content ^{B} | Conversion ^{C} |
| Example | (mmol) | [wt %] | [μmol] | Mooney | [ppm] | [%] |
| B1 | S1 (0.49) | 0.14 | 0.98 | 52.1 | 175 | 71 |
| B2 | S1 (0.49) | 0.14 | 0.66 | 53.3 | 160 | 65 |
| B3 | S1 (2.45) | 0.72 | 0.49 | 54.9 | 455 | 37 |
| B4 | S2 (0.25) | 0.08 | 0.10 | 66.8 | 146 | 83 |
| B5 | S2 (0.51) | 0.16 | 0.13 | 67.8 | 210 | 59 |

^{A} Amount of Platinum added as Platinum-divinyltetramethyldisiloxane complex
^{B} Obtained from ICP measurement, the amount of Si of unmodified SSBR-1/SSBR-2 was deducted
^{C} Amount of silane consumed, calculated from the Si content (obtained from ICP measurement) of the polymers B1-B5

### Copolymerization of 1,3-Butadiene with Styrene

### Example (C1)

The co-polymerization was performed in a double wall, 10 liter steel reactor, which was first purged with nitrogen, before the addition of organic solvent, monomers, polar coordinator compound, initiator compound or other components. The polymerization reactor was tempered to 40° C., unless stated otherwise. The following components were then added in the following order: cyclohexane solvent (4600 grams); butadiene monomer (12.89 mol), styrene monomer (1.783 mol), tetramethylethylene diamine (TMEDA), and the mixture was stirred for one hour, followed by titration with n-butyl lithium to remove traces of moisture or other impurities. To initiate the polymerization reaction, n-butyl lithium was added into the polymerization reactor. The polymerization was performed for 80 minutes, not allowing the polymerization temperature to exceed 60° C. Afterwards, 0.5% of the total butadiene monomer amount was added, followed by the addition of the coupling agent. The mixture was stirred for 10 minutes. Subsequently, 1.8% of the total butadiene monomer amount was added, followed by the addition of the chain end modifier. The mixture was stirred for 20 minutes. For the termination of the polymerization process, one mol methanol per mol n-butyl lithium was added together with 2.20 g IRGANOX 1520 as stabilizer for the polymer. This mixture was stirred for 15 minutes. The resulting polymer solution was than stripped with steam for one hour to remove solvent and other volatiles, and dried in an oven at 70° C. for 30 minutes and then additionally for one to three days, at room temperature.

### Copolymerization of 1,3-Butadiene with Styrene and Subsequent Hydrosilylation

### Examples P1-P4

The copolymerizations were performed in accordance to the preparation of comparative example C1 (amount of reagents are summarized in Table 3). Additionally, after the termination of the polymerization reaction with methanol, the reactor temperature was raised to 70° C. followed by the addition of the silane and the catalyst dissolved in cyclohexane. The mixture was stirred for 40 minutes at this temperature. The polymer solution was worked up as in the comparative example C1.

The resulting polymer composition and several of its properties are summarized in Table 3 and Table 4 below.

TABLE 3
Composition of Examples—amounts of reagents for polymerization components.

| | | | | | | Chain End | |
|---|---|---|---|---|---|---|---|
| | n-BuLi | SnCl₄ | Silane | Pt^{A} | eq. Silane/ | Modifier (E1) | TMEDA |
| Ex. | [mmol] | [mmol] | [mmol] | [mmol] | n-BuLi | [mmol] | [mmol] |
| C1 | 4.390 | 0.345 | — | — | — | 3.860 | 8.823 |
| P1 | 4.351 | 0.305 | 10.78 | 0.022 | 2.5 | 3.924 | 8.725 |
| | | | (S1) | | (0.20 wt %) | | |
| P2 | 4.298 | 0.361 | 53.81 | 0.108 | 12.5 | 3.868 | 8.784 |
| | | | (S1) | | (1.00 wt %) | | |
| P3 | 4.301 | 0.354 | 10.76 | 0.022 | 2.5 | 3.800 | 8.829 |
| | | | (S3) | | (0.16 wt %) | | |
| P4 | 4.309 | 0.364 | 10.82 | 0.002 | 2.5 | 3.840 | 8.739 |
| | | | (S1) | | (0.20 wt %) | | |

^{A}amount of Platinum added as Platinum-divinyltetramethyldisiloxane complex

TABLE 4
Polymer Characterizations

| | | | | Coupling | Mooney | Vinyl | Styrene |
|---|---|---|---|---|---|---|---|
| | Mw | Mn | Mp | Rate^{A} | viscosity | content^{B} | content^{C} |
| Example | [g/mol] | [g/mol] | [g/mol] | [%] | [MU] | [wt %] | [wt %] |
| C1 | 427553 | 313319 | 297958 | 20.4 | 57.4 | 63.8 | 20.7 |
| P1 | 415308 | 310821 | 304495 | 18.7 | 55.3 | 63.8 | 20.9 |
| P2 | 467789 | 330841 | 307763 | 24.6 | 71.6 | 63.9 | 20.9 |
| P3 | 435564 | 316614 | 300347 | 22.7 | 54.1 | 62.8 | 20.9 |
| P4 | 459320 | 328290 | 302801 | 25.8 | 55.6 | 63.5 | 20.8 |

^{A}determined by SEC
^{B}vinyl content is that of the 1,2-polybutadiene unit content of the final copolymer, and is determined by IR Spectroscopy
^{C}styrene content of the final copolymer, and is determined by IR Spectroscopy

### Polymer Compositions

Polymer compositions were prepared by combining the compounds listed in Table 5 below, in a 380 mL internal batch mixer (Brabender 350S) and vulcanized at 160° C. for 20 minutes. Vulcanization process data and physical properties are summarized in Table 6 and Table 7.

TABLE 5
Polymer composition using polymers C1, 1, 2, 3

| Components | Amount (phr)^{a} |
|---|---|
| 1^{st} mixing stage | |
| SSBR | 80 |
| High cis 1,4-polybutadiene (Buna cis 132-Schkopau^{b}) | 20 |
| Precipitated silica (Silica 7000GR^{c}) | 80 |
| Silane (Si 75^{c,d}) | 6.9 |
| Stearic acid^{e} | 1.0 |
| Antiozonant (Dusantox 6 PPD^{f}) | 2.0 |
| Zinc oxide^{g} | 2.5 |
| Ozone protecting wax (Antilux 654^{h}) | 1.5 |
| Softener (TDAEⁱ) | 20 |
| 2^{nd} mixing stage | |
| Sulfur^{j} | 1.4 |
| Accelerator (TBBS^{k}) | 1.5 |
| DPG^{l} | 1.5 |

^{a}Based on sum weight of the styrene butadiene copolymer and high cis 1,4-polybutadiene
^{b}Styron Deutschland GmbH
^{c}Evonic GmbH
^{d}Bis(triethoxysilylpropyl)disulfan, sulfur equivalents per molecule: 2.35
^{e}Cognis GmbH
^{f}N-(1,3-dimethylbutyl)-N′-phenyl-1,4-benzenediamine, Duslo a.s.
^{g}Grillo-Zinkoxid GmbH
^{h}Light & ozone protective wax, Rhein Chemie Rheinau GmbH
ⁱVivaTec 500, Hansen & Rosenthal KG
^{j}Solvay AG
^{k}N-tert-Butyl-2-benzothiazyl-sulfenamide; Rhein Chemie Rheinau GmbH
^{l}Diphenylguanidine, Vulkacit D, Lanxess AG

TABLE 6
Vulcanization Process Data & Silica Containing
Polymer Vulcanizate Composition Property

| | Compound | | | | | | Heat |
|---|---|---|---|---|---|---|---|
| | Mooney | TS 1 | TS 2 | TC 50 | TC 90 | TC 95 | build-up |
| Example | [Mu] | [min] | [min] | [min] | [min] | [min] | [° C.] |
| C1A | 73.6 | 0.90 | 2.74 | 6.60 | 15.77 | 20.77 | 120.6 |
| 1A | 80.7 | 0.62 | 2.17 | 6.24 | 15.31 | 20.47 | 118.8 |
| 2A | 87.8 | 0.54 | 1.94 | 6.13 | 15.33 | 20.44 | 115.1 |
| 3A | 80.1 | 0.82 | 2.51 | 6.17 | 15.64 | 20.78 | 118.2 |

TABLE 7
Silica Containing Polymer Vulcanizate Composition Properties

| | Elongation | Tensile | Modulus | Rebound | Rebound | Tan δ | Tan δ | Tan δ | Temp. at |
|---|---|---|---|---|---|---|---|---|---|
| | at Break | Strength | 300 | resilience | resilience | at | at | at | Tan δ max |
| Example | [%] | [MPa] | [MPa] | @ 0° C. | @ 60° C. | −10° C. | 0° C. | 60° C. | [° C.] |
| C1A | 413 | 18.9 | 12.0 | 15.8 | 57.0 | 0.3976 | 0.2950 | 0.1286 | −22 |
| 1A | 371 | 18.1 | 12.6 | 14.6 | 59.4 | 0.4285 | 0.3058 | 0.1140 | −22 |
| 2A | 358 | 17.4 | 12.9 | 14.8 | 59.8 | 0.3863 | 0.2868 | 0.1221 | −22 |
| 3A | 387 | 19.5 | 13.1 | 14.4 | 60.6 | 0.4455 | 0.3062 | 0.1098 | −22 |

One important application of the present invention is the production of vulcanized (elastomeric) polymer compositions having lower heat build-up, lower “tan δ at 60° C.” values and higher “rebound resilience at 60° C.” values, while “tan δ at 0° C.”, “tan δ at −10° C.” values (higher=better) and rebound resilience at 0° C. values (lower=better) are improved or at a similar level. If one of the three values (heat build-up, tan δ at 60° C., rebound resilience at 60° C.), which relate to a tire rolling resistance, is improved, the other three values, which relate to the tire wet grip (tan δ at 0° C., rebound resilience at 0° C.) performance and tire ice grip (tan δ at −10° C.) performance, should not be negatively affected in order to improve the key tire performance properties. Tire treads made from polymer compositions having lower heat build-up, lower “tan δ at 60° C.” and higher rebound resilience at 60° C. values have corresponding lower rolling resistance, while those having higher “tan δ at 0° C.” and lower rebound resilience at 0° C. values have corresponding better wet skid properties, while those with higher “tan δ at −10° C.” values have corresponding better ice grip properties.

In order to demonstrate the backbone modification according to the present invention, a) modified low molecular weight high vinyl polybutadiene were made as examples (as described above, examples O1-O4) and b) modified SSBR were made as examples (as described above, examples B1-B5). The degree of hydrosilylation of the modified polybutadiene oligomers was determined by NMR spectroscopy, whereas the hydrosilylation degree of the SSBR was determined by ICP spectroscopy. The amount of reagents and the conversion of the modification of a) polybutadiene oligomers and b) SSBR, are summarized in Table 1 and Table 2.

It was found that the hydrosilylation of SSBR with silanes according to the present invention (described herein) produce backbone modified polymers which can be used for the preparation of elastomeric polymer compositions and, furthermore, for the preparation of vulcanized elastomeric polymer compositions. The vulcanized elastomeric polymer compositions based on polymers made by the backbone modification using the silane compounds of the invention (see example 3A in Table 6 and Table 7) have relatively lower (or reduced) values for tan δ at 60° C. and rebound resilience at 0° C.; relatively higher (or increased) values for rebound resilience at 60° C. and tan δ at −10° C. and relatively decreased tire heat built up, when compared with a vulcanized elastomeric polymer compositions based on other polymers, not comprising the backbone modification according to the invention (see comparative example C1A in Table 6 and Table 7). Exemplary vulcanized composition 3A, which is based on modified polymer 3, modified with silane S3 of the invention, has a rebound resilience at 60° C. value of 60.6%, a tan δ value at −10° C. of 0.4455 and a tan δ value at 60° C. of 0.1098, while vulcanized composition C1A, which is based on non-backbone modified polymer C1, has a relatively lower rebound resilience value at 60° C. of 57.0%, a relatively lower tan δ value at −10° C. of 0.3976 and a relatively higher tan δ value at 60° C. of 0.1286.

The polymer preparation and the polymer characteristics of the polymers used in the preparation of silica-containing polymer compositions and vulcanizates formed thereof are summarized in Table 3 and Table 4. The compounding and vulcanization formulations are summarized in Table 5. As illustrated in Table 5, “silica-containing” polymer compositions are prepared from polymers which are backbone-modified by using silane compounds according to the present invention.

In Table 3 and Table 4, polymers 1, 2, 3 and 4 are representative examples of the present invention.

The polymers of the invention may be converted into polymer compositions (first stage mixing [representing the mixing step in which the silica filler is added to the modified polymer] and second stage mixing according to Table 5, comprising silica filler and modified polymer according to the invention), then further converted into vulcanized polymer compositions, which are formed when, for example, the second stage mixing result according to Table 5 is cured at 160° C. for 20 min as described herein. The polymer compositions and vulcanized polymer compositions as listed in Table 6 and Table 7, prepared under identical conditions on the same day by a single operator, are identified with the capital letter A. The polymer contained in the vulcanized polymer composition is reflected by the polymer number, e.g. 1, 2, etc. As a result, there is one vulcanized polymer composition series wherein the polymer composition C1A, 1A, 2A and 3A can directly be compared with each other.

As shown in Table 6, “heat build-up” during dynamic deformation of the vulcanized polymer compositions of the invention is reduced, while “tan δ at 60° C.” is decreased (Tables 9 and 11) and rebound resilience at 60° C. is increased. Polymer “heat build-up” reduction is believed to reduce the vulcanizate hysteresis energy loss, leading to a decreased rolling resistance, and to an increased overall elasticity. A reduced “tan δ at 60° C.” and an increased rebound resilience at 60° C. indicate a decrease of the vulcanizate hysteresis energy loss leading to a decreased rolling resistance. “Tan δ at 0° C.” or “tan δ at −10° C.” values are increased or at least in a similar range compared with vulcanizates of comparative polymer Cl, indicating improved or at least similar grip properties on a wet or icy surface. “Tensile Strength” and “Modulus 300” are not or not significantly deteriorated in comparison with the reference polymer, suggesting the formation of a stable polymer network with a higher resistance under mechanical stress. Although “Elongation at Break” values are slightly reduced, they are still very acceptable considering the degree of improvement of the tan δ, heat built up and abrasion resistance values.

1. A modified elastomeric polymer which is the reaction product of:
i) a copolymer of butadiene and one or more comonomers selected from conjugated dienes and aromatic vinyl compounds, wherein the copolymer contains at least 10 wt % of butadiene units and a total amount of at least 40 wt % of conjugated diene units and wherein the polybutadiene fraction of the copolymer has a vinyl group content of at least 30 wt %, and
ii) a silane modifier represented by the following Formula 1:
(H)ₙSi(X)ₘ(R¹)ₚ (Formula 1),
wherein
X is independently selected from Cl, —OR², —SR³ and —NR⁴R⁵;
R¹ is independently selected from (C1-C6) alkyl and (C6-C18) aryl;
n is an integer selected from 1, 2 and 3; m and p are each independently an integer selected from 0, 1, 2 and 3; and n+m+p=4;
R² and R³ are independently selected from hydrogen, (C1-C18) alkyl, (C6-C18) aryl, (C7-C18) alkylaryl and MR⁶R⁷R⁸;
R⁴ and R⁵ are independently selected from (C1-C18) alkyl, (C6-C18) aryl, (C7-C18) alkylaryl and MR⁹R¹⁰R¹¹; R⁴ and R⁵ may be bonded together to form, together with the nitrogen atom, a ring structure which may additionally include within the ring one or more groups selected from —O—, —S—, >NH and >NR¹²;
M is silicon or tin;
R⁶, R⁷, R⁸, R⁹, R¹⁰, R¹¹ and R¹² are independently selected from (C1-C6) alkyl.

2. The modified elastomeric polymer according to claim 1, wherein X is independently selected from —OR² and —NR⁴R⁵, R¹ is independently selected from methyl, ethyl, propyl, butyl and phenyl, n is 1, m is an integer selected from 1, 2 and 3 and p is an integer selected from 0, 1 and 2.

3. The modified elastomeric polymer according to claim 1, wherein the silane modifier of Formula 1 is selected from HSi(OMe)₃, HSi(Me)(OMe)₂, HSi(Me)₂(OMe), HSi(Et)(OMe)₂, HSi(Et)₂(OMe), HSi(Pr)(OMe)₂, HSi(Pr)₂(OMe), HSi(Bu)(OMe)₂, HSi(Bu)₂(OMe), HSi(Ph)(OMe)₂, HSi(Ph)₂(OMe), HSi(OEt)₃, HSi(Me)(OEt)₂, HSi(Me)₂(OEt), HSi(Et)(OEt)₂, HSi(Et)₂(OEt), HSi(Pr)(OEt)₂, HSi(Pr)₂(OEt), HSi(Bu)(OEt)₂, HSi(Bu)₂(OEt), HSi(Ph)(OEt)₂, HSi(Ph)₂(OEt), tris(trimethylsiloxy)silane, HSi(Cl)₃, H₂Si(Cl)₂, HSi(Me)(Cl)₂, HSi(Me)₂(Cl), HSi(Et)(Cl)₂, HSi(Et)₂(Cl), HSi(Pr)(Cl)₂, HSi(Pr)₂(Cl), HSi(Bu)(Cl)₂, HSi(Bu)₂(Cl), HSi(Ph)(Cl)₂, HSi(Ph)₂(Cl₂), H₂Si(Ph)(Cl), HSi(Ph)(Me)(Cl), 1,1,1,3,5,5,5-heptamethyltrisiloxane, (Me)₂NSi(H)(Me)₂, (Et)₂NSi(H)(Me)₂, (Pr)₂NSi(H)(Me)₂, (Bu)₂NSi(H)(Me)₂, ((Me)₂N)₂Si(H)(Me), ((Et)₂N)₂Si(H)(Me), ((Pr)₂N)₂Si(H)(Me), ((Bu)₂N)₂Si(H)(Me), ((Me)₂N)₃Si(H), ((Et)₂N)₃Si(H), ((Pr)₂N)₃Si(H), ((Bu)₂N)₃Si(H), (Me)₂NSi(H)(Ph)₂, (Et)₂NSi(H)(Ph)₂, (Pr)₂NSi(H)(Ph)₂, (Bu)₂NSi(H)(Ph)₂, ((Me)₂N)₂Si(H)(Ph), ((Et)₂N)₂Si(H)(Ph), ((Pr)₂N)₂Si(H)(Ph), ((Bu)₂N)₂Si(H)(Ph), (Me)₂NSi(H)(Cl)₂, (Et)₂NSi(H)(Cl)₂, (Pr)₂NSi(H)(Cl)₂, (Bu)₂NSi(H)(Cl)₂, ((Me)₂N)₂Si(H)(Cl), ((Et)₂N)₂Si(H)(Cl), ((Pr)₂N)₂Si(H)(Cl) and ((Bu)₂N)₂Si(H)(Cl).

4. The modified elastomeric polymer according to claim 1, wherein the conjugated diene is selected from isoprene, 2,3-dimethyl-1,3-butadiene, 1,3-pentadiene, 2,4-hexadiene, 1,3-hexadiene, 1,3-heptadiene, 1,3-octadiene, 2-methyl-2,4-pentadiene, cyclopentadiene, 2,4-hexadiene, 1,3-cyclohexadiene and 1,3-cyclooctadiene, preferably selected from isoprene and cyclopentadiene.

5. The modified elastomeric polymer according to claim 1, wherein the aromatic vinyl compound is selected from styrene, 2-methylstyrene, 3-methylstyrene, 4-methylstyrene, 2,4-dimethylstyrene, 2,4,6-trimethylstyrene, α-methylstyrene, 2,4-diisopropylstyrene, 4-tert-butylstyrene, stilbene, vinyl benzyl dimethylamine, (4-vinylbenzyl)dimethyl aminoethyl ether, N,N-dimethylaminoethyl styrene, tert-butoxystyrene, vinylpyridine, 1,2-divinylbenzene, 1,3-divinylbenzene and 1,4-divinylbenzene, preferably styrene.

6. The modified elastomeric polymer according to claim 1, wherein the aromatic vinyl compound(s) constitute(s) from 5 to 60 wt % of the total monomer content of the polymer.

7. The modified elastomeric polymer according to claim 1, wherein the copolymer is selected from styrene-butadiene rubber, butadiene-isoprene rubber and butadiene-isoprene-styrene rubber, preferably styrene-butadiene rubber with a styrene content of from 5 to 60% by weight of the total monomer content and even more preferably from 10 to 50% by weight of the total monomer content.

8. The modified elastomeric polymer according to claim 1, which contains a structural group of one or both of the following Formulas 11-a and 11-b: 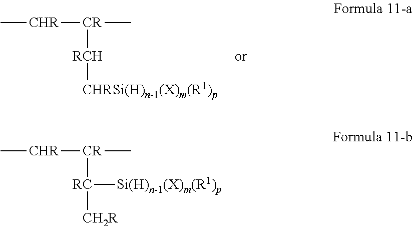
wherein R¹, X, n, m, p are as defined in claim 1 and R is independently selected from H and C1-C5 alkyl.

9. The modified elastomeric polymer according to claim 1, which contains a structural group of one or both of the following Formulas 11-c and 11-d: 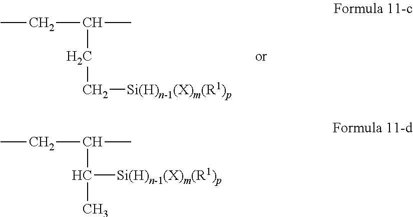
wherein R¹, X, n, m, p are as defined in claim 1.

10. The modified elastomeric polymer according to claim 1, which is further modified with one or more chain end-modifying agents.

11. A method of making a modified elastomeric polymer as defined in claim 1, the method comprising the steps of reacting
i) a copolymer of butadiene and one or more comonomers selected from conjugated dienes and aromatic vinyl compounds, wherein the copolymer contains at least 10 wt % of butadiene units and at least 40 wt % of conjugated diene units and the polybutadiene fraction of the copolymer has a vinyl group content of at least 30 wt %, with
ii) a silane modifier represented by Formula 1 as defined in claim 1, 2 or 3.

12. The method of making a modified elastomeric polymer according to claim 11, wherein the silane modifier of Formula 1 is added intermittently or continuously during the polymerization of butadiene and conjugated diene and aromatic vinyl compound.

13. The method of making a modified elastomeric polymer according to claim 11, wherein the silane modifier of Formula 1 is added at a time when the conversion rate of the polymerization has reached 80 wt % or more.

14. The method of making a modified elastomeric polymer according to claim 11, wherein the silane modifier of Formula 1 is used in a total amount of from 0.001 to 5 wt %, based on the weight of the copolymer.

15. A non-cured polymer composition comprising the modified elastomeric polymer of the invention as defined in claim 1 and one or more further components selected from (i) components which are added to or formed as a result of the polymerization process and/or backbone modification process used for making the polymer, (ii) components which remain after solvent removal from the polymerization and/or backbone modification process, and (iii) components which are added to the polymer after completion of the polymerization and/or backbone modification process.

16. The non-cured polymer composition according to claim 15, which comprises one or more fillers.

17. The non-cured polymer composition according to claim 15, which comprises one or more extender oils.

18. The non-cured polymer composition according to claim 15, wherein the modified elastomeric polymer constitutes at least 15 wt % of the total polymer present, more preferably at least 25 wt %, even more preferably at least 35 wt %.

19. The non-cured polymer composition according to claim 15, which comprises one or more vulcanizing agents.

20. A vulcanized polymer composition which is obtained by vulcanizing a non-cured polymer composition as defined in claim 19.

21. An article comprising at least one component formed from the vulcanized polymer composition as defined in claim 20.

22. The article according to claim 21, which is a tire, a tire tread, a tire side wall, a tire carcass, a belt, a gasket, a seal, a hose, a vibration damper, a golf ball or a footwear component.
